(19) United States
(12) Patent Application Publication
(10) Pub. No.: US 2025/0343590 A1
(43) Pub. Date: Nov. 6, 2025

(54) ELECTRONIC DEVICE AND METHOD FOR WIRELESS COMMUNICATION, AND INFORMATION PROCESSING DEVICE

(71) Applicant: Sony Group Corporation, Tokyo (JP)

(72) Inventors: Mingtuo ZHOU, Shanghai (CN); Xiaoxue WANG, Beijing (CN); Haojin LI, Beijing (CN)

(73) Assignee: Sony Group Corporation, Tokyo (JP)

(21) Appl. No.: 18/867,455

(22) PCT Filed: May 23, 2023
(86) PCT No.: PCT/CN2023/095740

§ 371 Date: Nov. 20, 2024

(30) Foreign Application Priority Data
May 27, 2022 (CN) 202210586272.9

(51) Int. Cl. H04B 7/06; H04B 7/185; H04W 64/00

(52) U.S. Cl. CPC H04B 7/06958; H04B 7/1855; H04W 64/00

(57) ABSTRACT

Provided are an electronic device and method for wireless communication, and an information processing device. The electronic device for wireless communication can comprise a processing circuit, wherein the processing circuit can be configured to: receive data from a network-side device, the data being sent by using one or both of the current beam and the next beam at least partially on the basis of the relationship between the location of a user equipment and a coverage overlapping area of the current beam and the next beam for he user equipment.

The present application claims priority to Chinese Patent Application No. 202210586272.9, titled “ELECTRONIC DEVICE AND METHOD FOR WIRELESS COMMUNICATION, AND INFORMATION PROCESSING DEVICE”, filed on May 27, 2022 with the China National Intellectual Property Administration, which is incorporated herein by reference in its entirety.

### FIELD

The present disclosure relates to the technical field of wireless communications, and in particular to an electronic device and a method for wireless communication, an information processing device, and a non-transitory computer-readable storage medium that facilitate determining a downlink beam.

### BACKGROUND

With the development of technology, there are many scenarios in which people carry user equipments (UEs) in high-speed movement and expect to perform wireless communication as usual. For example, when people travel at high speeds on transportation vehicles (such as ground vehicles like trains or near-ground vehicles like airplanes), the UEs that people carry move at high speeds within coverage regions of base stations (terrestrial base stations or base stations in a non-terrestrial network (NTN)) along the way, and quickly pass through coverage regions of different downlink beams within a coverage region of each of the base stations (each of cells).

In addition, with increasingly widespread usage of the non-terrestrial network, in many scenarios, base stations in the non-terrestrial network use or control satellites or high-speed high-altitude platforms that move relative to the ground to emit downlink beams to transmit data to user equipments. In a situation in which no beam fixation technology is adopted, projections of the wireless communication beams used by the base stations in the non-terrestrial network on the ground move rapidly, with speeds up to several kilometers per second. In this situation, the user equipments pass through the coverage regions of the downlink beams of each of the base stations very quickly.

In situations, such as but not limited to the above situation in which beam coverage time of each of the beams is short, to ensure that a base stations transmits data to UEs always with appropriate downlink beams, it is required to continuously perform beam measurement on the downlink beams between the base station and the UEs, so that the base station performs beam switching based on beam measurement results.

### SUMMARY

A brief summary of the present disclosure is given below to provide a basic understanding in some aspects of the present disclosure. It should be understood that the summary is not an exhaustive summary of the present disclosure. The summary is not intended to determine a critical part or an important part of the present disclosure or limit the scope of the present disclosure. A purpose of the summary is only to provide some concepts in a simplified manner, serving as a preamble of a more detailed description described later.

In view of the above problems, according to an object of one aspect of the present disclosure, an electronic device and a method for wireless communication are to be provided with which data transmission is performed using an appropriate downlink beam based on a relationship between a position of a user equipment and a beam overlapping region, thereby reducing dependence on beam measurement.

Correspondingly, according to a first aspect of the present disclosure, an electronic device for wireless communication is provided. The electronic device includes processing circuitry. The processing circuitry is configured to: transmit data to a user equipment using one of or both a current beam and a next beam for a user equipment at least partly based on a relationship between a position of the user equipment and an overlapping coverage region of the current beam and the next beam.

According to the first aspect of the present disclosure, a method for wireless communication is further provided. The method includes: transmitting data to a user equipment using one of or both a current beam and a next beam for a user equipment at least partly based on a relationship between a position of the user equipment and an overlapping coverage region of the current beam and the next beam.

In addition, according to a second aspect of the present disclosure, an electronic device for wireless communication is provided. The electronic device includes processing circuitry. The processing circuitry is configured to: receive data from a network-side device, where the data is transmitted using one of or both a current beam and a next beam for a user equipment at least partly based on a relationship between a position of the user equipment and an overlapping coverage region of the current beam and the next beam.

According to the second aspect of the present disclosure, a method for wireless communication is further provided. The method includes: receiving data from a network-side device, where the data is transmitted using one of or both a current beam and a next beam for a user equipment at least partly based on a relationship between a position of the user equipment and an overlapping coverage region of the current beam and the next beam.

According to an object of another aspect of the present disclosure, an information processing device is to be provided for providing information about a predetermined movement path of a transportation vehicle to the electronic device for wireless communication according to the first aspect.

Correspondingly, according to a third aspect of the present disclosure, an information processing device is provided. The information processing device includes processing circuitry. The processing circuitry is configured to: transmit information about a predetermined movement path of a transportation vehicle to an electronic device for wireless communication, so that the electronic device determines a relationship between a position of a user equipment on the transportation vehicle and an edge of an overlapping coverage region of a current beam and a next beam for the user equipment at least partially based on the information, so as to transmit data to the user equipment using one of or both the current beam and the next beam.

In addition, according to the third aspect of the present disclosure, an information processing method is further provided. The method includes: transmitting information about a predetermined movement path of a transportation vehicle to an electronic device for wireless communication, so that the electronic device determines a relationship between a position of a user equipment on the transportation vehicle and an edge of an overlapping coverage region of a current beam and a next beam for the user equipment at least partially based on the information, so as to transmit data to the user equipment using one of or both the current beam and the next beam.

According to yet another aspect of the present disclosure, a non-transitory computer-readable storage medium storing executable instructions is further provided. The executable instructions, when executed by a processor, cause the processor to perform functions of the device (the electronic device for wireless communication or the information processing device) according to the present disclosure or perform the method (the method for wireless communication or the information processing method) according to the present disclosure.

According to other aspects of the present disclosure, computer program codes and computer program products for performing the method according to the present disclosure are further provided.

According to at least one aspect of the present disclosure, data transmission may be performed using an appropriate downlink beam based on a relationship between a position of a user equipment and a beam overlapping region, thereby reducing dependence on beam measurement.

Other aspects of the embodiments of the present disclosure are provided in the following specification, in which preferred embodiments for fully disclosing the embodiments of the present disclosure are described in detail without imposing restrictions on the embodiments of the present disclosure.

### BRIEF DESCRIPTION OF THE DRAWINGS

The accompanying drawings described herein only illustrate selected embodiments rather than all possible implementations, and are not intended to limit the scope of the present disclosure. In the drawing:

FIGS. 1A and 1B are schematic diagrams showing an aircraft route passing through satellite beams;

FIG. 1C is a table showing an example of relevant parameters of satellite beams and transportation vehicles;

FIG. 1D is a schematic diagram showing an example of a beam coverage time period of a satellite beam for an aircraft;

FIG. 2 is a block diagram showing a configuration example of an electronic device according to a first embodiment of the present disclosure;

FIG. 3 is a block diagram showing a configuration example of a relationship unit in the electronic device shown in FIG. 2;

FIG. 4 is a schematic diagram showing an example of a user equipment UE on an aircraft passing through a coverage region of a current beam and a coverage region of a next beam;

FIG. 5 is a schematic diagram showing partial exemplary information exchange between a base station-side device (gNB), a UE, and an information processing device (server);

FIG. 6 is a schematic diagram showing another example of a user equipment UE on an aircraft passing through a coverage region of a current beam and a coverage region of a next beam;

FIG. 7 is a schematic diagram showing partial exemplary information exchange between a gNB and a UE;

FIG. 8 is a schematic diagram showing partial exemplary information exchange between a gNB and a UE;

FIG. 9 is a schematic diagram showing partial exemplary information exchange between a gNB and a UE;

FIG. 10 is a schematic diagram showing partial exemplary information exchange between a gNB and a UE;

FIG. 11 is a block diagram showing a configuration example of an electronic device according to a second embodiment of the present disclosure;

FIG. 12 is a block diagram showing a configuration example of an information processing device according to a third embodiment of the present disclosure;

FIG. 13 is a flowchart showing an exemplary process of a method for wireless communication according to the first embodiment of the present disclosure;

FIG. 14 is a flowchart showing an exemplary process of a method for wireless communication according to the second embodiment of the present disclosure;

FIG. 15 is a flowchart showing an exemplary process of an information processing method according to the third embodiment of the present disclosure;

FIG. 16 is a block diagram showing an example of a schematic configuration of a server to which the technology of the present disclosure may be applied;

FIG. 17 is a block diagram showing a first example of a schematic configuration of an eNB to which the technology of the present disclosure may be applied;

FIG. 18 is a block diagram showing a second example of a schematic configuration of an eNB to which the technology of the present disclosure may be applied;

FIG. 19 is a block diagram showing an example of a schematic configuration of a smartphone to which the technology according to the present disclosure may be applied; and

FIG. 20 is a block diagram showing an example of a schematic configuration of a vehicle navigation device to which the technology according to the present disclosure may be applied.

Although the present disclosure may be susceptible to various modifications and alternative forms, specific embodiments thereof have been shown by way of examples in the drawings and have been described in detail herein. However, it should be understood that the description of specific embodiments herein is not intended to limit the present disclosure to the particular forms disclosed, but rather to cover all modifications, equivalents, and alternatives falling within the spirit and scope of the present disclosure. It should be noted that same or similar reference numerals are used throughout the drawings to refer to the same or like parts.

### DETAILED DESCRIPTION OF EMBODIMENTS

The embodiments of the present disclosure will be described completely in conjunction with the drawings. The following description is only exemplary, and is not intended to limit the present disclosure, and applications or usages thereof.

Exemplary embodiments are provided so that the present disclosure will be thorough and complete, and will fully convey the scope of the present disclosure to those skilled in the art. Numerous specific details, such as examples of specific components, devices, and methods, are described to provide a detailed understanding of the embodiments of the present disclosure. It is apparent for those skilled in the art that the exemplary embodiments may be implemented in many different forms without specific details, and should not be construed to limit the scope of the present disclosure. In some exemplary embodiments, well-known processes, well-known structures, and well-known technologies are not described in detail.

The descriptions are provided in the following order:
1. Summary;
2. Configuration examples of an electronic device in a first embodiment;
3. Configuration examples of an electronic device in a second embodiment;
4. Configuration examples of an information processing device in a third embodiment;
5. Method embodiments; and
6. Application examples.

### 1. SUMMARY

As mentioned above, when people, for example, travel at high speeds on transportation vehicles (such as ground vehicles like trains or near-ground vehicles like airplanes), the user equipments that people carry move at high speeds within coverage regions of base stations (terrestrial base stations or base stations in a non-terrestrial network) along the way, and even move at high speeds within coverage regions of different downlink beams of each of the base stations. In addition, in a non-terrestrial networks, projections of wireless communication beams transmitted by satellites (low-earth-orbit satellites or medium-orbit satellites) or high-speed high-altitude platforms that move relative to the ground under the control of the base stations move quickly on the ground.

In the above situations in which the user equipment moves at high speeds and/or the projections of the beams used by the base stations in the non-terrestrial network serving the user equipment move quickly, the user equipment quickly passes through the coverage regions of the different downlink beams.

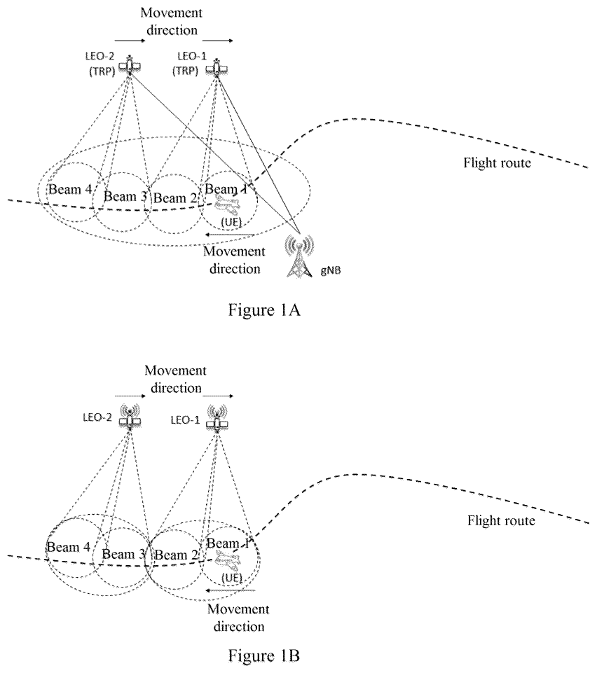

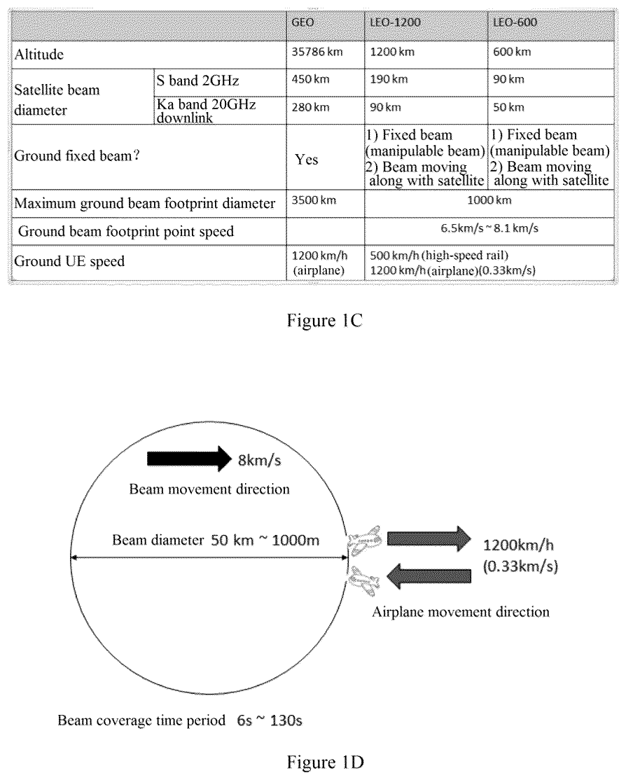

As an example, FIGS. 1A and 1B show schematic diagrams of an aircraft route passing through satellite beams. In the example shown in FIG. 1A, a base station gNB in a non-terrestrial network is located on the ground and communicates with a core network device (not shown) on the ground. In a satellite cell of the base station gNB, two low earth orbit (LEO) satellites serve as transmit receive points (TRP) for coverage, that is, different beams of beam 1 and beam 2 of a satellite LEO-1 and different beams of beam 3 and beam 4 of a satellite LEO-2 are used in a same cell. When passing through the satellite cell of the base station gNB, the aircraft sequentially passes through the coverage regions of the beam 1 to the beam 4, and the UEs on the aircraft perform three beam switching processes. The difference between the example in FIG. 1B and FIG. 1A is that the satellites LEO-1 and LEO-2 in FIG. 1B are non-transparent satellites. That is, the satellites LEO-1 and LEO-2 themselves serve as base stations in the non-terrestrial network, and, for example, communicate directly with the core network device (not shown) on the ground. Thus, When passing through the satellite cell of LEO-1 or LEO-2, the aircraft passes through coverage regions of different beams, and the UEs on the aircraft perform one beam switching process.

FIG. 1C shows an example of relevant parameters of satellite beams and high-speed transportation vehicles, and FIG. 1D shows an example of a beam coverage time period of a satellite beam of a LEO satellite without using beam fixation technology for an aircraft that is calculated based on the parameters shown in FIG. 1C. As shown in FIG. 1D, due to the movement of the aircraft and the movement of the beam projection, the time period for the aircraft (UEs on the aircraft) to be covered by a beam is very short. Specifically, in this example, if it is assumed that the movement direction of the beam projection on the ground is exactly the same as the flight direction of the aircraft, the time period in which the aircraft is covered is only 6.51 seconds in a case that the diameter of the beam projection is 50 kilometers, and the time period is 130 seconds in a case that the diameter of the beam projection is 1000 kilometers. If it is assumed that the movement direction of the beam projection is completely opposite to the flight direction of the aircraft, the time periods in the above two cases are 6 seconds and 120 seconds respectively. In any one of these cases, the beam coverage time period is very short.

In the above cases in which the beam coverage time period of each of the beams is short, in order to ensure that the base station always transmits data to the UEs using appropriate downlink beams, it is required to continuously perform downlink beam measurement between the base station and the UEs for the base station to perform beam switching based on beam measurement results.

In the present disclosure, it is noted by the inventors that the beam coverage time period of each of the beams, such as in the above cases, is relatively short, and an inventive concept of performing data transmission using appropriate downlink beams at least partly based on a relationship between a position of a user equipment and an overlapping coverage region of a current beam and a next beam for the user equipment is provided, thereby reducing dependence on beam measurement.

Next, devices and methods according to the embodiments of the present disclosure are further described. It should be noted that although the above description and following specific description are performed partially with the application scenarios in which the user equipment is on a transportation vehicle and/or served by a base station in a non-terrestrial network as examples, the embodiments of the present disclosure are not limited to the above application scenarios, and may be appropriately applied to any scenario in which the beam coverage time period is short, which is be repeated herein.

### 2. CONFIGURATION EXAMPLES OF AN ELECTRONIC DEVICE IN A FIRST EMBODIMENT

### Configuration Examples

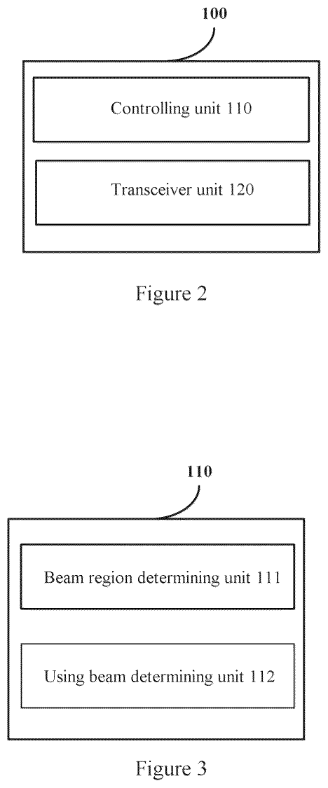

FIG. 2 is a block diagram showing a configuration example of an electronic device according to a first embodiment of the present disclosure. The electronic device shown in FIG. 2 may be used at the base station side, for example, may be used as a base station-side device in a non-terrestrial network, such as the base station gNB shown in FIG. 1A or the non-transparent satellite (having functions of a base station) LEO-1 or LEO-2 shown in FIG. 1B.

As shown in FIG. 2, an electronic device 100 may include a controlling unit 110 and a transceiver unit 120. The controlling unit 110 may control overall operations of the electronic device 100, and the transceiver unit 120 may, for example, transmit information to an external device of the electronic device 100 and/or receive information from an external device of the electronic device 100 under the control of the controlling unit 110. In addition, although not shown in FIG. 2, the electronic device 100 may further include a storage unit.

All the units of the electronic device 100 may be included in processing circuitry. It should be noted that the electronic device 100 may include one processing circuitry or multiple processing circuitry. Further, the processing circuitry may include various discrete functional units to perform various functions and/or operations. It should be noted that the functional units may be physical entities or logical entities, and units with different titles may be implemented by the same physical entity.

According to the first embodiment, the controlling unit 110 of the electronic device 100 may, at least partly based on a relationship between a position of a user equipment and an overlapping coverage region of a current beam (a current downlink beam) and a next beam (a next downlink beam) for the user equipment, determine the current beam, the next beam, or both the current beam and the next beam as a using beam.

FIG. 3 shows a block diagram of a configuration example of the controlling unit 110 of the electronic device 100. As shown in FIG. 3, the controlling unit 110 may include a beam region determining unit 111 and a using beam determining unit 112.

The beam region determining unit 111 may obtain the position of the user equipment, and then determine the current beam, the next beam, and overlapping coverage region for the user equipment based on the position of the user equipment. The overlapping coverage region has edges, including an entry-side edge for the user equipment to enter the overlapping coverage region and an exit-side edge for the user equipment to leave the overlapping coverage region.

The beam region determining unit 111 may obtain the position of the user equipment in various ways. For example, the beam region determining unit 111 may receive position information reported (such as reported in real time, reported periodically, reported at a predetermined position, or reported in a case of meeting other predetermined conditions) by the user equipment through the transceiver unit 120 of the electronic device 100. The position information includes, for example, a geographic position, an altitude (optional), a time instant (a measurement time instant at which the geographic position/altitude is obtained) of the user equipment, and the like.

In a preferred example, the user equipment may be on a transportation vehicle with a predetermined movement path, and the beam region determining unit 111 may receive information about the predetermined movement path of the transportation vehicle from another device (such as an information processing device arranged at a core network or at a cloud service platform) via the transceiver unit 120 of the electronic device 100. The information about the predetermined movement path of the transportation vehicle, for example, may include information indicating: an identifier (ID) of the transportation vehicle and/or a number of the movement path (such as flight number/train number), a geographic position (and an optional altitude) along the movement path, and time associated with the geographic position (and the optional altitude) along the movement path. Optionally, the information may further include information indicating a movement direction (associated with the geographic position (and the optional altitude) along the movement path and the time).

The beam region determining unit 111 may determine a current position of the user equipment and obtain a predicted position of the user equipment based on the obtained information, for determining the current beam and the next beam for the user equipment. For example, when continuously obtaining position information reported by the user equipment, the controlling unit 110 may determine a current position of the user equipment based on current position information, and may estimate a movement path (including a movement direction) of the user equipment based on previous position information and current position information to obtain a predicted position of the user equipment. When receiving information about the predetermined movement path of the transportation vehicle at which the user device is located from another device, the controlling unit 110 may obtain a current position and a predicted position of the user equipment, for example, based on an association between a geographic position (and an optional altitude) and time in the information.

The beam region determining unit 111 may determine a current beam and a next beam for the user equipment based on, for example, the current position and the predicted position of the user equipment obtained in the above manner and coverage regions of various downlink beams (downlink beams emitted by the electronic device 100 having base station functions or downlink beams emitted by other devices, such as a TRP or a transparent satellite, controlled by the electronic device 100) controlled by the beam region determining unit 111. In the present disclosure, as an example, a coverage region of a beam may be defined as a region around a center position of a coverage region of a beam (that is, a position with a highest beam quality of the beam) and bounded by a given beam quality (that is, using a given beam quality (for example, a signal strength such as −140 dBm) as an contour line).

As an example, the beam region determining unit 111 may determine a beam that covers the current position of the user equipment as a current beam for the user equipment, and determine a beam, which covers the predicted position of the user equipment and is immediately adjacent to the current beam along the movement direction of the user equipment, as a next beam for the user equipment. Thus, it should be noted that the predicted position of the user equipment is separated from the current position of the user equipment by a certain distance, which may be achieved through appropriate processing by the beam region determining unit 111 in estimating the predicted position (such as estimating a predicted position after moving for a certain time period and/or distance, continuously estimating multiple predicted positions, and the like).

The beam region determining unit 111 may further determine an overlapping coverage region (referred to as the overlapping region/area when appropriate in this specification) of the current beam and the next beam for the user equipment, that is, an overlapping region between a coverage region of the current beam and a coverage region of the next beam. As mentioned above, in the present disclosure, a region around a center of a coverage region of a beam and bounded by a given beam quality is defined as a coverage region of the beam, so that boundaries (or edges) of coverage regions of two adjacent beams defined in the above way intersect, and the region within the intersection range is an overlapping coverage region. The beam region determining unit 111 preferably determines an entry-side edge for the overlapping coverage region, and optionally further determines an exit-side edge for the overlapping coverage region.

Optionally, the beam region determining unit 111 may use the transceiver unit 120 of the electronic device 100 to provide one or more of information about the current beam, information about the next beam, and information about an edge of the overlapping coverage region to the user equipment. The information about the current/next beam includes but is not limited to beam indication information of the beam, and the information about the edge of the overlapping coverage region includes but is not limited to position information of the edge. Optionally, the beam region determining unit 111 may forward information about the predetermined movement path of the transportation vehicle to the user equipment on the transportation vehicle using the transceiver unit 120 of the electronic device 100 when appropriate (described later).

The using beam determining unit 112 may determine one or both of the current beam and the next beam as a using beam at least partly based on a relationship between the position of the user equipment obtained by the beam region determining unit 111 and the overlapping coverage region, particularly, the edge of the overlapping coverage region, determined by the beam region determining unit 111 according to one or more predetermined rules.

In an example, the predetermined rule according to which the using beam determining unit 112 determines a using beam may include: determining whether to perform beam measurement based on the relationship between the position of the user equipment and the edge of the overlapping coverage region, and determining a using beam based on the relationship and optionally a beam measurement result. In another example, the predetermined rule according to which the using beam determining unit 112 determines a using beam may include: determining a using beam only based on the relationship between the position of the user equipment and the edge of the overlapping coverage region, without any beam measurement.

After the controlling unit 110 determines one or both of the current beam and the next beam as the using beam, for example, by using the using beam determining unit 112 shown in FIG. 3 based on the predetermined rule, the transceiver unit 120 may transmit data to the user equipment with the using beam. Alternatively, the transceiver unit 120 may provide the user equipment with information related to the predetermined rule for determining the using beam by the controlling unit 110 (the using beam determining unit 112) in advance (described later).

The configuration examples of the electronic device 100 in the first embodiment are described above. With the electronic device 100 according to the first embodiment, the dependence on beam measurement can be reduced. For example, the beam measurements to be performed may be reduced, thereby reducing energy consumption and signaling interaction associated with beam measurement.

Next, with appropriate reference to exemplary scenarios, exemplary processes performed by electronic device 100 using the units, especially the controlling unit 110, are further described.

### Exemplary Processes of Determining a Beam Region

In this example, the user equipment is on a transportation vehicle with a predetermined movement path, and the electronic device 100 may, by using the controlling unit 110 (such as the beam region determining unit 111), receive information about the predetermined movement path of the transportation vehicle from another device (such as an information processing device arranged on a core network or a cloud service platform) via the transceiver unit 120, and it may determine the position, the current beam, and the next beam of the user equipment at least partly based on the information about the predetermined movement path. The electronic device 100 may further, by using the controlling unit 110 (such as the beam region determining unit 111), determine the overlapping coverage region (including the edge of the overlapping coverage region) based on the determined coverage regions of the current beam and the next beam.

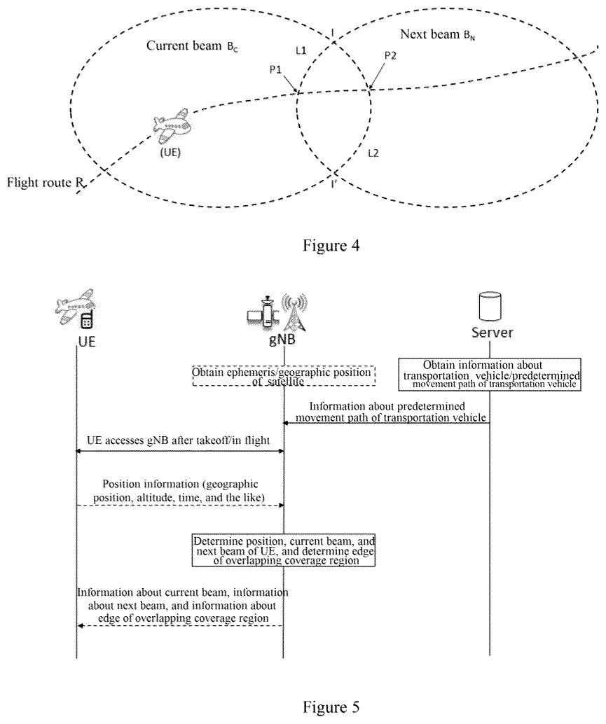

FIG. 4 schematically shows an example of a user equipment UE on an aircraft passing through a coverage region of a current beam and a coverage region of a next beam controlled by the electronic device 100. The electronic device 100, for example, may obtain information about a flight route R of the aircraft shown in FIG. 4 from another device, may determine, by using the controlling unit 110 (the beam region determining unit 111) positions of the user equipment at different time instants based on the association of geographic positions and altitudes with time in the information, and then obtains beams, including the current beam B_{C} and the next beam B_{N} as shown in FIG. 4, for the user equipment at different time instants based on the positions of the user equipment and the coverage regions of downlink beams controlled by the electronic device 100.

The electronic device 100 may further, by using the controlling unit 110 (the beam region determining unit 111), based on that a boundary of the current beam B_{C} and a boundary of the next beam B_{N} intersects at points I and I′, determine a boundary of the current beam B_{C} between points I and I′ as an entry-side edge L1, determine a boundary of the next beam B_{N} between the points I and I′ as an exit-side edge L2, and then determine an overlapping coverage region between the entry-side edge L1 and the exit-side edge L2. Optionally, the electronic device 100 may further, by using the controlling unit 110 (the beam region determining unit 111), determine a predicted position of the user equipment reaching an edge (such as a predicted entry position P1 and a predicted exit position P2 shown in FIG. 4) based on the predetermined movement path of the transportation vehicle (such as the flight route shown in FIG. 4) and position of edges (such as the entry-side edge L1 and the exit-side edge L2 shown in FIG. 4) of the overlapping coverage region.

The electronic device 100 may provide one or more of information about the current beam, information about the next beam, and information about the overlapping coverage region (the edge of the overlapping coverage region) to the user equipment, for example, through the transceiver unit 120. As an example, the information about the edge of the overlapping coverage region may indicate at least one of: a position of the edge (such as a position of the edge L1 and/or L2 shown in FIG. 4) of the overlapping coverage region; and a predicted position (such as the predicted position P1 and/or P2 shown in FIG. 4) of the user equipment reaching the edge that is determined based on the predetermined movement path and the position of the edge. Optionally, in a case that the relevant determining process is based on the information about the predetermined movement path of the transportation vehicle, the electronic device 100 may further provide information about the predetermined movement path of the transportation vehicle to the user equipment via the transceiver unit 120 for reference by the user equipment.

FIG. 5 schematically shows exemplary information exchange, related to the exemplary processes of determining a beam region, between a base station-side device (gNB) having the functions of the electronic device 100, a user equipment UE, and an information processing device (Server) such as a server for providing movement path information of a transportation vehicle.

As shown in FIG. 5, the gNB (an electronic device 100 used for the gNB) may, for example, obtain information about a movement path of a transportation vehicle in advance (or continuously), and after the user equipment UE accesses, after takeoff or during flight, the gNB, the gNB may optionally obtain position information reported by the UE after accessing the gNB (or reported regularly or periodically). The gNB (the electronic device 100 used for the gNB) may determine the position, the current beam, and the next beam of the UE based on information about the movement path of the transportation vehicle and optionally the position information reported by the UE in the manner described above, and may further determine an edge of the overlapping coverage region, and then provide information about the current beam, information about the next beam, and information about the edge of the overlapping coverage region to the UE. Optionally, although not shown in the figure, the gNB may further provide the UE with information about the predetermined movement path of the transportation vehicle along with this information or in addition to this information. The gNB may further provide the UE with information about one or more predetermined rules for subsequently determining a using beam by the base station side along with or in addition to this information (described later).

In the example shown in FIG. 5, the electronic device 100 used for the gNB, for example, may determine that the UE is on the transportation vehicle by comparing the information about the movement path of the transportation vehicle with the position information reported by the UE. After the UE accesses the gNB, the gNB and the UE may perform the position information, the determining process of the current/next beam and the edge of the overlapping coverage region, and notification process of information related to the current/next beam and the edge of the overlapping coverage region in various ways; for example, the above processes may be performed periodically, may be performed after the UE passes through a position of the edge, and may be performed after performing beam switching.

In an example, the electronic device 100 may be a base station (such as the gNB shown in FIG. 1A or LEO-1 or LEO-2 shown in FIG. 1B) in a non-terrestrial network, and may, by using the controlling unit 110 (the beam region determining unit 111), determine the current beam and the next beam of the user equipment based on the information about the predetermined movement path of the transportation vehicle and further based on a ephemeris (and optionally a geographic position) of a satellite that is used for transmitting a downlink beam and controlled by the base station in the non-terrestrial network. For example, the electronic device 100 may, by using the controlling unit 110 (the beam region determining unit 111), determine a movement trajectory of a coverage region of each of beams based on the ephemeris of the satellite, and then obtain, based on the movement trajectory of the coverage region of each of the beams, and positions of the user equipment at different time instants determined according to the association between geographic positions/altitudes with time in the information about the predetermined movement path of the transportation vehicle, beams for the user equipment at different time instants, such as the current beam B_{C} and the next beam B_{N} shown in FIG. 4. Thus, in the example shown in FIG. 5, the electronic device 100 used for gNB may, for example, obtain an ephemeris and/or geographic position information of a satellite in advance.

In addition, although not shown in the example shown in FIG. 5, the electronic device 100 may optionally, by using the controlling unit 110 (the beam region determining unit 111), start a timer set for updating the ephemeris and/or geographic position (and optionally a satellite antenna mode) of the satellite, after the user equipment (UE) accesses the base station (gNB) in the non-terrestrial network. After the timer expires, the electronic device 100 may determine whether the ephemeris and/or geographic position (and optionally the satellite antenna mode) of the satellite controlled by the base station in the non-terrestrial network is updated. In a case that the ephemeris and/or geographic position (and optionally the satellite antenna mode) of the satellite is updated, the electronic device 100 may determine the current beam and the next beam of the user equipment (and optionally further determine the edge of the overlapping coverage region) based on the updated ephemeris and/or geographic location position (and optionally the updated satellite antenna mode). Optionally, the electronic device 100 may further provide the various information determined after the updating to the user equipment. The timer may be periodic or non-periodic. By using the timer, the accuracy of determining the current beam and the next beam (and optionally the edge of the overlapping coverage region) can be ensured.

Based on the information about the current beam, the information about the next beam, and the information about the edge of the overlapping coverage region (and optionally the information about the predetermined movement path of the transportation vehicle and the information about the predetermined rules for determining a using beam) that are obtained from the electronic device 100, the user equipment may monitor whether the user equipment itself is in the overlapping coverage region (such as whether the user equipment reaches the edge of the overlapping coverage region), and may determine the beam region where the user equipment is (and may determine the using beam the user equipment is using, which is described later).

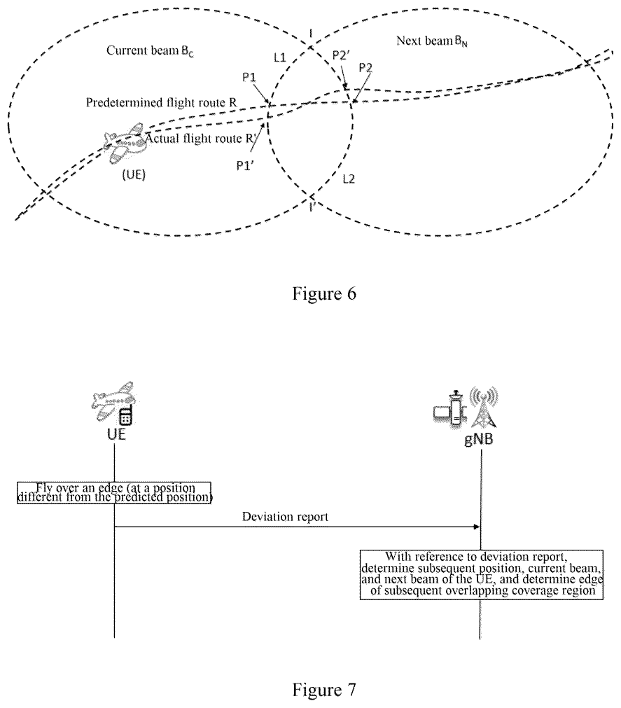

In actual operations of transportation vehicles, such as airplanes, buses, ships, and even trains, there may be situations in which an actual path deviates from a predetermined path. FIG. 6 shows an example of a UE on an aircraft passing through a coverage region of a current beam and a coverage region of a next beam, in which an actual flight route R′ of the aircraft deviates from a predetermined flight route R. In this situation, the actual positions (P1′, P2′) at which the user equipment reaches the edges (L1, L2) of the overlapping coverage region may be inconsistent with the predicted positions (P1, P2) at which the user equipment reaches the edges indicated by the information about the edge of the overlapping coverage region provided by the electronic device 100.

In view of the above situation, in the case that the information obtained by the user equipment from the electronic device 100 about the edge of the overlapping coverage region indicates the predicted positions at which the user equipment reaches the edges, the user equipment may transmit, when an actual position of the user equipment reaching the edge is inconsistent with the predicted position, a deviation report that indicates the inconsistency. Correspondingly, the electronic device 100 may receive a deviation report through the transceiver unit 120 that is transmitted from the user equipment when an actual position of the user equipment reaching the edge is inconsistent with the predicted position and that indicates the inconsistency. Optionally, the electronic device 100 may, by using the controlling unit 110 (the beam region determining unit 111), determine the position, the current beam and the next beam (for subsequent usage) of the user equipment with reference to the deviation report.

FIG. 7 schematically shows partial exemplary information exchange related to a deviation report between a base station-side device gNB having functions of an electronic device 100 and a user equipment UE. As shown in FIG. 7, for example, after the UE passes through edges (L1, L2) of an overlapping coverage region at actual positions (P1′, P2′) that are different from predicted positions (P1, P2), the UE generates and transmits a deviation report for indicating the inconsistency of the actual positions and the predicted positions, which may be in a form of deviation values (P1′−P1, P2′−P2), to the gNB (having the functions of the electronic device 100). The gNB may correct the position of the UE and the movement path of the transportation vehicle where the UE is located with reference to the deviation report. For example, the gNB may add a deviation value, such as (P1′−P1) and/or (P2′−P2) or an average of (P1′−P1) and (P2′−P2), to a current position/a next position/all subsequent positions of the UE indicated by the information about the predetermined movement path of the transportation vehicle, thereby realizing correction. The gNB may determine a current position, current beam, and next beam of the UE thereafter based on the corrected movement path in the above manner, and optionally determine the edge of the subsequent overlapping coverage region. Although not shown in FIG. 7, the gNB may provide UE with information about the current beam, information about the next beam, and information about the edge of the overlapping coverage region that are determined in the above manner and after correction processing. The exemplary process shown in FIG. 7 may be performed every time the aircraft flies over the edge of the overlapping coverage region, for continuously performing correction based on a latest deviation.

### Exemplary Processes of Determining a Using Beam

In this example, exemplary processes are discussed in which the electronic device 100, for example, by using the controlling unit 110 (the using beam determining unit 112), determines one or both of the current beam and the next beam as a using beam based on one or more predetermined rules for determining a using beam and at least partially based on a relationship between a position of the user equipment and an edge of an overlapping coverage region (for example, obtained by using the beam region determining unit 111).

As an example, the electronic device 100 may, for example, by using the controlling unit 110 (the using beam determining unit 112), determine the relationship between the position of the user equipment and the edge of the overlapping coverage region, such as whether the position of the user equipment is close to (arriving at) or far from the edge of the overlapping coverage region, based on position information reported by the user equipment and/or information about the predetermined movement path of the transportation vehicle.

For example, based on a first predetermined rule for determining a using beam, the electronic device 100 may use only a current beam for the user equipment as the using beam in a case that the position of the user equipment is far away from the edge of the overlapping coverage region. Specifically, the electronic device 100 may determine that the position of the user equipment is far from the edge of the coverage overlap region (far from the coverage overlap region) in a case that the position of the user equipment is within a predetermined distance (the distance may be configured appropriately, and the distance, for example, may be proportional to the radius of the coverage region of the beam) from a center of the coverage region of the current beam, and thus the electronic device 100 may directly determine to only use the current beam for the user equipment as the using beam in a case of not performing any beam measurement with the user equipment. The electronic device 100 may, by using the transceiver unit 120, transmit information about the first predetermined rule to the user equipment in advance (for example, provided together with information about the current beam, information about the next beam, and information about the edge of the overlapping coverage region shown in FIG. 5), so that the user equipment may understand that the downlink beam actually used by the base station side is the “current beam” indicated by the previously received information about the current beam (for example, referring to FIG. 5) when the user equipment is far away from the overlapping coverage region.

In addition, the electronic device 100 may determine a using beam based on other predetermined rules (such as but not limited to a second predetermined rule, a third predetermined rule, or a fourth predetermined rule described later) when the user equipment is near the overlapping coverage region.

As an example, the electronic device 100 may determine that the position of the user equipment reaches the edge of the overlapping coverage region (near the overlapping coverage region) when the position of the user equipment is within a predetermined distance (the distance may be configured appropriately, and, for example, may be proportional to the radius of the coverage region of beam) from a center of the predicted positions (the predicted positions of the user equipment reaching the edge that are determined based on the predetermined movement path of the transportation vehicle and the position of the edge of the overlapping coverage region, such as the predicted entry position P1 and the predicted exit position P2 shown in FIG. 4) on the edge of the coverage region. Optionally, in a case that the electronic device 100 provides information about the edge of the overlapping coverage region to the user equipment and the information indicates the predicted position of the user equipment reaching the edge, the user equipment may determine whether the user equipment has reached the edge of the overlapping coverage region (near the overlapping coverage region) based on a similar rule when needed, and transmits an edge reaching report to the electronic device 100 when the user equipment reaches the entry-side edge and/or the exit-side edge of the overlapping coverage region, so that the electronic device 100 knows that the user equipment has reached a corresponding edge (near the overlapping coverage region).

For the situation that the position of the user equipment is near the overlapping coverage region (such as approaching or entering the overlapping coverage region, within the overlapping coverage region, and leaving the overlapping coverage region), the electronic device may, by using the controlling unit 110 (the using beam determining unit 112), determine the using beam based on one or more predetermined rules for determining a using beam (such as but not limited to a second predetermined rule, a third predetermined rule, or a fourth predetermined rule described later).

### Examples of Determining a Using Beam Partially Based on Beam Measurement Near an Overlapping Coverage Region

In this example, the electronic device 100 may determine to perform beam measurement based on the position of the user equipment reaching the edge of the overlapping coverage region (such as an entry-side edge), and determines a using beam based on a beam measurement result.

More specifically, the electronic device 100 may not perform beam measurement with the user equipment before the user equipment reaches the entry-side edge of the overlapping coverage region, performs beam measurement for the next beam with the user equipment, by using the controlling unit 110 (the using beam determining unit 112), after the user equipment reaches the entry-side edge, receives, by using the transceiver unit 120, a beam measurement result from the user equipment, and determines, by using the controlling unit 110 (the using beam determining unit 112), one or both of the current beam and the next beam based on the beam measurement result, and transmits, by using the transceiver unit 120, data to the user equipment with the determined using beam.

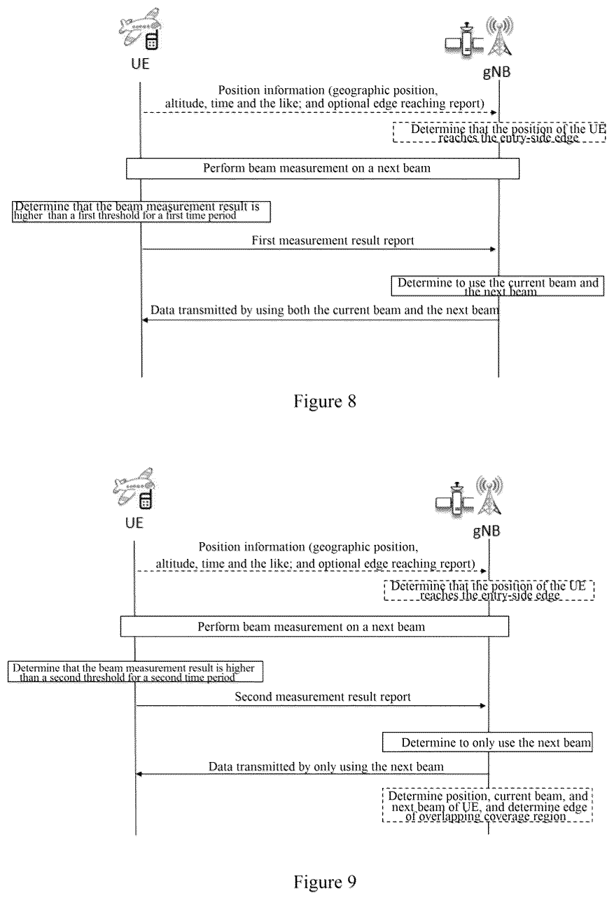

FIGS. 8 and 9 schematically show exemplary information exchanges between a gNB and a UE related to the exemplary processes for determining a using beam described above. In FIGS. 8 and 9, a second predetermined rule for determining a using beam and a third predetermined rule for determining a using beam are respectively adopted, and the gNB transmits information about the corresponding predetermined rule to the UE in advance (for example, provided together with the information about the current beam, the information about the next beam, and the information about the edge of the overlapping coverage region shown in FIG. 5).

As shown in FIGS. 8 and 9, the gNB having the functions of the electronic device 100 may determine that the position of the user equipment reaches the entry-side edge of the overlapping coverage region (such as determining that the UE is close to the predicted entry position Pl shown in FIG. 4) based on the position information reported by the user equipment UE, or know that the position of the user equipment reaches the entry-side edge based on the edge reaching report reported by the user equipment, and then performs beam measurement on a next beam with the UE. The measurement, for example, may be performed through the gNB controlling (such as after generating and transmitting an optional measurement notification to the UE to indicate time-frequency resources and a beam direction of the next beam) to continuously transmit (such as a satellite controlled by the gNB to continuously transmit) a next beam such as B_{N} shown in FIG. 4 and the UE continuously measuring a beam quality of the next beam (such as the UE receiving and measuring the downlink beam based on the time-frequency resources and the beam direction indicated by the measurement notification), which is not repeated herein.

According to the second predetermined rule for determining a using beam, the base station determines to use both the current beam and the next beam in a case that a beam measurement result of the next beam is higher than a first threshold for a first time period after the position of the user equipment reaches the entry-side edge of the overlapping coverage region.

As shown in FIG. 8, in performing beam measurement on the next beam (such as the next beam B_{N} shown in FIG. 4), in a case that the beam measurement result of the next beam is higher than a first threshold for a first time period, the user equipment UE may generate a first measurement result report and transmit the first measurement result report to the gNB. That is, the gNB, having the functions of the electronic device 100, may receive, through the transceiver unit 120, a first measurement result report that is transmitted from the user equipment UE in a case that the beam measurement result of the next beam (such as the next beam B_{N} shown in FIG. 4) is higher than a first threshold for the first time period. Furthermore, the gNB, having the functions of the electronic device 100, may determine to use both the current beam and the next beam by using the controlling unit 110 (the using beam determining unit 112) based on the first measurement result report, and transmit data to the user equipment UE by using the transceiver unit 120 with both the current beam and the next beam. Correspondingly, the UE may receive data transmitted by the gNB using both the current beam and the next beam.

In the manner shown in FIG. 8, after the UE reaches the entry-side edge of the overlapping coverage region, when the beam quality of the next beam remains good for a time period, it is considered that the UE has entered the overlapping coverage region and the beam quality of the next beam is acceptable. Therefore, the gNB performs downlink data transmission using both beams, which is beneficial for improving the transmission quality in the overlapping coverage region (for example, using only the current beam or only the next beam may result in poor transmission quality). Alternatively, if the UE enters the overlapping coverage region and the beam quality of the next beam cannot remain good for a time period, the gNB performs downlink data transmission still using only the current beam. With the above process, it can be avoided to continuously measure the current beam.

In addition, according to the third predetermined rule for determining a using beam, the base station determines to only use the next beam in a case that a beam measurement result of the next beam is higher than a second threshold for a second time period after the position of the user equipment reaches the entry-side edge of the overlapping coverage region.

As shown in FIG. 9, in performing beam measurement on the next beam (such as the next beam B_{N} shown in FIG. 4), in a case that the beam measurement result of the next beam is higher than a second threshold for a second time period, the user equipment UE may transmit a second measurement result report to the gNB. That is, the gNB, having the functions of the electronic device 100, may receive, through the transceiver unit 120, a second measurement result report that is transmitted from the user equipment UE in a case that the beam measurement result of the next beam (such as the next beam B_{N} shown in FIG. 4) is higher than a second threshold for the second time period. Furthermore, the gNB, having the functions of the electronic device 100, may determine to use only the next beam by using the controlling unit 110 (the using beam determining unit 112) based on the second measurement result report, and transmit data to the user equipment UE by using the transceiver unit 120 only with the next beam. Correspondingly, the UE may receive data transmitted by the gNB using only the next beam. Preferably, the second threshold is higher than the first threshold and/or the second time period is longer than the first time period. The exemplary information exchange shown in FIG. 9 may be performed in parallel with the exemplary information exchange shown in FIG. 8, or may be performed after the exemplary information exchange shown in FIG. 8 (that is, the second predetermined rule and the third predetermined rule may be used simultaneously or sequentially), which is not limited in the present disclosure.

In the manner shown in FIG. 9, after the UE reaches the entry-side edge of the overlapping coverage region, when the beam quality of the next beam remains good for a long time period or remains excellent for a time period, it is considered that the UE has passed through the overlapping coverage region and entered the coverage region of the next beam, so that the gNB performs downlink data transmission only using the next beam. Alternatively, if the UE enters the overlapping coverage region and the beam quality of the next beam cannot remain good for a long time period or remain excellent for a time period, the gNB performs downlink data transmission still using the current using beam (that is, only the current beam, or both the current beam and the next beam). With the above process, it can be avoided to continuously measure the current beam.

### Examples of Determining a Using Beam While Avoiding Beam Measurement Near an Overlapping Coverage Region

In this example, the electronic device 100 may directly determine a using beam based on the position of the user equipment reaching the edge of the overlapping coverage region, without performing beam measurement.

More specifically, according to a fourth predetermined rule for determining a using beam, the base station side determines to use both the current beam and the next beam when the position of the user equipment reaches the entry-side edge of the overlapping coverage region, and determines to use the next beam when the position of the user equipment reaches the exit-side edge. The electronic device 100 may not perform beam measurement with the user equipment before the user equipment reaches the entry-side edge of the overlapping coverage region. The electronic device 100 may determine, by using the controlling unit 110 (the using beam determining unit 112), to use both the current beam and the next beam when the user equipment reaches the entry-side edge, so as to transmit data, by using the transceiver unit 120, to the user equipment using both the current beam and the next beam; determine, by using the controlling unit 110 (the using beam determining unit 112), to use the next beam when the user equipment reaches the exit-side edge, so as to transmit data, by using the transceiver unit 120, to the user equipment only using the next beam.

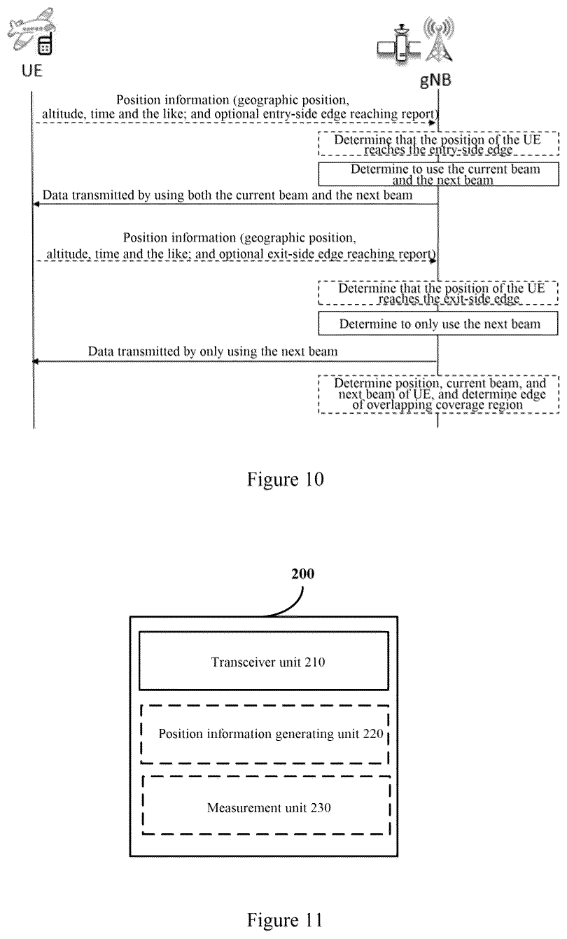

FIG. 10 schematically shows exemplary information exchanges between a gNB and a UE related to the exemplary processes for determining a using beam described above. In FIG. 10, a fourth predetermined rule for determining a using beam is adopted, and the gNB transmits information about the predetermined rule to the UE in advance (for example, provided together with the information about the current beam, the information about the next beam, and the information about the edge of the overlapping coverage region shown in FIG. 5).

As shown in FIG. 10, the gNB, having the functions of the electronic device 100, may determine that the position of the user equipment reaches the entry-side edge or the exit-side edge of the overlapping coverage region (such as determining that the UE is close to the predicted entry position Pl or the predicted exit position P2 shown in FIG. 4) based on the position information reported by the user equipment UE, or know that the position of the user equipment reaches the entry-side edge or the exit-side edge based on the edge reaching report reported by the user equipment. According to the fourth predetermined rule for determining a using beam, the gNB may not perform beam measurement, and determine to use a corresponding beam to transmit data to the user equipment only based on the position of the user equipment reaching a corresponding edge.

In the manner shown in FIG. 10, after the UE reaches the entry-side edge of the overlapping coverage region and before the UE reaches the exit-side edge of the overlapping coverage region, the gNB performs downlink data transmission using both the current beam and the next beam, which is beneficial for improving the transmission quality in the overlapping coverage region (for example, using only the current beam or only the next beam may result in poor transmission quality). In addition, after the UE reaches the exit-side edge of the overlapping coverage region, it is considered that the UE has passed through the overlapping coverage region and entered the coverage region of the next beam, so that the gNB performs downlink data transmission only using the next beam. In this manner, beam switching is performed only based on geographic positions without performing any beam measurement in this example, thereby reducing energy consumption and signaling interaction related to beam measurement.

In the example shown in FIG. 8, FIG. 9 or FIG. 10, the gNB, having the functions of the electronic device 100, transmits information about the second predetermined rule, information about the third predetermined rule, or information about the fourth predetermined rule to the user equipment UE in advance (for example, provided together with the information about the current beam, the information about the next beam, and the information about the edge of the overlapping coverage region in FIG. 5) by using the transceiver unit 120, so that the UE may know the actual downlink beam used by the base station side according to a corresponding rule without real-time notification from the base station.

For example, in the example shown in FIG. 8 or FIG. 9, the UE may generate a first measurement result report or a second measurement result report, and at the same time, determine, according to the second predetermined rule or the third predetermined rule, the downlink beam actually used by the base station side being the “current beam” and the “next beam” indicated in the previously received information about the current beam and the information about the next beam, or the “next beam” indicated in the previously received information about the next beam. In the example shown in FIG. 10, the UE may determine the beam actually used based on the position of the UE according to the fourth predetermined rule.

In addition, alternatively or optionally, in the example shown in FIG. 8, FIG. 9 or FIG. 10, although not shown in the figures, the gNB, having the functions of the electronic device 100, may transmit a beam indication for an actual using beam to the UE by using the transceiver unit 120 before performing data transmission with a changed beam, so that the UE knows the actual using beam.

In addition, in the example shown in FIG. 9 or FIG. 10 (for the third predetermined rule or the fourth predetermined rule), in a case that the gNB having the functions of the electronic device 100 determines to perform downlink data transmission only using the next beam, it is considered that the UE has entered the coverage region of the next beam and performed beam switching, so the next beam B_{N} may be set to be a new current beam B_{C}. Alternatively, the electronic device 100 may then perform again the process of determining the position of the UE, the current beam and the next beam and the process of determining the edge of the overlapping coverage region by using the controlling unit 110 (the beam region determining unit 111) in a manner similar to the manner described above. Optionally, the position of the UE may be determined based on the position information reported by the UE and/or based on the information about the predetermined movement path of the transportation vehicle where the UE is located in a manner similar to the manner described above, or may be directly determined as the predicted position on the exit-side edge (such as the predicted exit position P2 shown in FIG. 4). The current beam of the UE may be determined directly based on the beam switching (a previous next beam B_{N} is set to be a new current beam B_{C}), and the next beam and the edge of the overlapping coverage region may be determined in a manner similar to the manner described above. Although not shown in FIG. 9 or FIG. 10, optionally, the electronic device 100 may provide the determined information to the user equipment UE for subsequent use by using the transceiver unit 120, which is not repeated herein.

The electronic device 100 (at the base station side) according to the first embodiment of the present disclosure is described above, which may perform data transmission using an appropriate downlink beam based on a relationship between a position of a user equipment and an overlapping coverage region, thereby reducing dependence on beam measurement.

In the above description of the electronic device 100 at the base station side according to the first embodiment of the present disclosure, in addition to the electronic device 100 at the base station side, the user equipment UE served by the electronic device 100 and other devices, such as an information processing device arranged at a core network or a cloud service platform server, that provide predetermined path information of transportation vehicles for the electronic device 100 are also described. That is, according to the embodiments of the present disclosure, in addition to the electronic device at the base station side, an electronic device at the user side and an information processing device are further provided. Hereinafter, based on the description of the electronic device at the base station side according to the first embodiment of the present disclosure, descriptions of an electronic device at the user side according to a second embodiment of the present disclosure and an information processing device according to a third embodiment of the present disclosure are provided, and unnecessary details are omitted.

### 3. CONFIGURATION EXAMPLES OF AN ELECTRONIC DEVICE IN A SECOND EMBODIMENT

FIG. 11 is a block diagram showing a configuration example of an electronic device at a user side according to a second embodiment of the present disclosure. The electronic device may be used for the user equipment UE (such as the UE on the airplane shown in FIG. 1A or FIG. 1B) served by the base station side device described in the base station side device of the first embodiment.

As shown in FIG. 11, an electronic device 200 may include a transceiver unit 210, and optionally a position information generating unit 220 and a measurement unit 230. The transceiver unit 210 may, for example, transmit information to an external device of the electronic device 200 and/or receive information from an external device of the electronic device 200. In addition, although not shown in FIG. 11, the electronic device 200 may further include a controlling unit for controlling overall operations/general operations of the electronic device 200 and a storage unit for storing functions.

All the units of the electronic device 200 may be included in processing circuitry. It should be noted that the electronic device 200 may include one processing circuitry or multiple processing circuitry. Further, the processing circuitry may include various discrete functional units to perform various functions and/or operations. It should be noted that the functional units may be physical entities or logical entities, and units with different titles may be implemented by the same physical entity.

According to the embodiment, the transceiver unit 210 may receive data from a network side-device. The data is transmitted using one of or both a current beam and a next beam for a user equipment at least partly based on a relationship between a position of the user equipment and an overlapping coverage region of the current beam and the next beam. The network side-device may be, for example, a device at the base station side (such as the base station gNB shown in FIG. 1A or the non-transparent satellite (having base station functions) LEO-1 or LEO-2 shown in FIG. 1B). The overlapping coverage region may have an edge, including an entry-side edge for the user equipment to enter the overlapping coverage region and an exit-side edge for the user equipment to leave the overlapping coverage region. In addition, optionally, the transceiver unit 210 may further receive a predetermined rule for determining a using beam, such as but not limited to one or more of the first predetermined rule to the fourth predetermined rule described in the first embodiment, from the network side-device.

The optional position information generating unit 220 may continuously monitor a position of a user equipment by using various positioning functions such as a global positioning system (GPS) module, and generate position information of the user equipment. The position information includes, for example, a geographic position, an altitude (optional), a time instant (a measurement time instant at which the geographic position/altitude is obtained), and the like of the user equipment. The position information generating unit 220 may use the transceiver unit 210 to report the generated position information (such as reporting in real time, reporting periodically, reporting at a predetermined position, or reporting in a case of meeting other predetermined conditions) to the network side-device for the network side-device to determine the position of the user equipment.

In a preferred example, the user equipment may be on a transportation vehicle with a predetermined movement path. Then, the network side-device may obtain information about the predetermined movement path of the transportation vehicle in various appropriate ways in advance, and may determine the position of the user equipment at least partly based on the information about the predetermined movement path.

As mentioned above, the network side-device (the base station side device) may determine a current beam and a next beam (such as the current beam B_{C} and the next beam B_{N} shown in FIG. 4) for the user equipment based on the position of the user equipment (where the position of the user equipment is determined based on the position information reported by the user equipment or information about the predetermined movement path of the transportation vehicle) and the coverage ranges of the downlink beams controlled by the network side-device, and it may further determine the overlapping coverage region (the edge of the overlapping coverage region, such as the entry-side edge L1 and/or the exit-side edge L2 shown in FIG. 4) of the current beam and the next beam. Optionally, the network side-device may determine a predicted position (such as P1 and P2 shown in FIG. 4) of the user equipment reaching the edge based on the predetermined movement path (such as the flight route R shown in FIG. 4) of the transportation vehicle and the position of the edge (such as L1 and L2 shown in FIG. 4) of the overlapping coverage region.

The electronic device 200 may obtain, for example, through the transceiver unit 210, one or more of information about the current beam, information about the next beam, and information the overlapping coverage region (the edge of the overlapping coverage region) from the network side-device. As an example, the information about the edge of the overlapping coverage region may indicate at least one of: a position of the edge (such as a position of the edge L1 and/or L2 shown in FIG. 4) of the overlapping coverage region; and a predicted position (such as the predicted position P1 and/or P2 shown in FIG. 4) of the user equipment reaching the edge that is determined based on the predetermined movement path and the position of the edge.

In addition, optionally, in a case where the network side-device obtains the information about the predetermined movement path of the transportation vehicle in which the user equipment is located and performs relevant determinations such as those for the current beam based on the information, the electronic device 200 may further receive the information about the predetermined movement path of the transportation vehicle by using the transceiver unit 210 from the network side-device.

As an example, the processes of the electronic device 200 reporting position information to the network side-device and the electronic device 200 receiving information about the current beam, information about the next beam, and information about the overlapping coverage region (the edge of the overlapping coverage region) (and optionally the information about the predetermined movement path of the transportation vehicle and the information about the predetermined rules for determining a using beam) from the network side may be performed through the exemplary information exchange described above with reference to FIG. 5. That is, the electronic device 200 used for the user equipment may perform all the functions or processes of the UE in the exemplary interactions described with reference to FIG. 5 by using the transceiver unit 210 and the position information generating unit 220, which is not repeated herein.

Based on the information about the current beam, the information about the next beam, and the information about the edge of the overlapping coverage region (and optionally the information about the predetermined movement path of the transportation vehicle and the information about the predetermined rules for determining a using beam) that are obtained from the network side-device, the electronic device 200 may monitor whether the electronic device 200 itself is in the overlapping coverage region (such as whether the electronic device 200 reaches the edge of the overlapping coverage region) by using the position information generating unit 220, and determine the beam region where the electronic device 200 is (and determine the using beam the electronic device 200 is using, which is described later).

In actual operations of transportation vehicles, there may be situations in which an actual path deviates from a predetermined path, such as the example in FIG. 6 in which the actual flight route R′ of the aircraft deviates from the predetermined flight route R. In this situation, as shown in FIG. 6, the actual positions (P1′, P2′) at which the user equipment reaches the edges (L1, L2) of the overlapping coverage region may be inconsistent with the predicted positions (P1, P2) at which the user equipment reaches the edges indicated by the information about the edge of the overlapping coverage region obtained from the network side-device.

In view of the above situation, in a case that the information about the edge of the overlapping coverage region obtained from the network side-device indicates the predicted position at which the user equipment reaches the edges, the position information generating unit 220 of the electronic device 200 may be configured to generate, when an actual position of the user equipment reaching the edge is inconsistent with the predicted position, a deviation report indicating the inconsistency, and transmit the deviation report to the network side-device by using the reception unit 210. As an example, the deviation report may indicate deviation values between the actual position (P1′, P2′) and the predicted positions (P1, P2), such as (P1′−P1, P2′−P2). The network side-device may correct the position of the user equipment and the movement path of the transportation vehicle where the user equipment is located with reference to the deviation report, and performs subsequent processes based on the corrected position and/or path.

As an example, the process of the electronic device 200 generating and transmitting the deviation report to the network side-device may be performed through the exemplary information exchange process described above with reference to FIG. 7. That is, the electronic device 200 used for the user equipment may perform all the functions or processes of the UE in the exemplary interactions described with reference to FIG. 7 by using the transceiver unit 210 and the position information generating unit 220, which is not repeated herein.

As mentioned above, the network side-device (the base station side device) may determine a using beam at least partially the relationship between the position of the user equipment and the overlapping coverage region (the edge of the overlapping coverage region) according to a predetermined rule for determining a using beam, and the electronic device 200 may receive the predetermined rule, such as but not limited to one or more of the first predetermined rule to the fourth predetermined rule described in the first embodiment, from the network side-device in advance (for example, receiving together with the information about the current beam, the information about the next beam, and the information about the edge of the overlapping coverage region shown in FIG. 5) through the transceiver unit 210. The electronic device 200 may perform appropriate processes based on the received predetermined rule for determining a using beam.

For example, in a case that the position of the user equipment is far away from the overlapping coverage region, according to the first predetermined rule for determining a using beam (using a current beam for the user equipment as the using beam when the user equipment is far away from the edge of the overlapping coverage region), the network side-device, after determining that the user equipment is far away from the edge of the overlapping coverage region (far from the overlapping coverage region), may use only the current beam for the user equipment as the using beam without performing any beam measurement with the user equipment.

Correspondingly, in a case of receiving the first predetermined rule (for example, receiving together with the information about the current beam, the information about the next beam, and the information about the edge of the overlapping coverage region shown in FIG. 5), the electronic device 200 at the user side may, for example, monitor the position of the electronic device 200 itself through the position information generating unit 220, and knows that the downlink beam actually used is the “current beam” indicated by the information about the current beam received from the network side-device (for example, referring to FIG. 5) when determining that the user equipment is far away from the edge of the overlapping coverage region (far from the overlapping coverage region). For example, the position information generating unit 220 may determine that the position of the user equipment is far from the edge of the coverage overlap region (far from the coverage overlap region) in a case that the position of the user equipment is within a predetermined distance (the distance, for example, is half or less of the radius of the coverage region of the current beam) from a center of the coverage region of the current beam, and then knows that the actual using beam is the “current beam” indicated by the information about the current beam.

In addition, for the situation in which the user equipment is near the overlapping coverage region, for example, according to the second predetermined rule for determining a using beam or the third predetermined rule for determining a using beam, the network side-device may determine to perform beam measurement based on the position of the user equipment reaching the edge (such as the entry-side edge) of the overlapping coverage region, and it may determine the using beam based on a beam measurement result. For example, according to the fourth predetermined rule for determining a using beam, the network side-device may determine the using beam only based on the position of the user equipment reaching the edge of the overlapping coverage region without performing beam measurement.

Correspondingly, the electronic device 200 at the user side, which receives the second predetermined rule, the third predetermined rule or the fourth predetermined rule, may, for example, monitor the position of the user equipment through the position information generating unit 220, determine whether the position of the user equipment reaches the edge of the overlapping coverage region, and then perform corresponding processes by using corresponding units according to corresponding predetermined rules (and optionally further instructions from the network side).

As an example, optionally, in a case that the network side-device provides information about the edge of the overlapping coverage region to the user equipment and the information indicates the predicted position at which the user equipment reaches the edge, for example, the position information generating unit 220 of the electronic device 200, which receives the second predetermined rule, the third predetermined rule or the fourth predetermined rule, may be configured to: determine whether the user equipment reaches an edge of the overlapping coverage region (near the overlapping coverage region), generate an edge reaching report when the user equipment reaches the entry-side edge and/or the exit-side edge, and transmit the edge reaching report to the network side-device by using the transceiver unit 210. Thus, the network side-device knows that the user equipment has reached an edge (near the overlapping coverage region). For example, the position information generating unit 220 may determine that the position of the user equipment reaches the edge of the overlapping coverage region (near the overlapping coverage region) in a case that the position of the user equipment is within a predetermined distance (where the distance, for example, is a quarter or less of the radius of the coverage region of the current beam) from the center of the predicted position (such as the position P1 or P2 shown in FIG. 4) on the edge of the overlapping coverage region.

In addition, in an example, in a case that the network side-device uses the second predetermined rule or the third predetermined rule and determines to perform beam measurement based on the position of user equipment reaching the edge (such as the entry-side edge) of the overlapping coverage region, for example, the optional measurement unit 230 of the electronic device 200, which receives the second predetermined rule or the third predetermined rule, may determine that the position of user equipment reaches the edge of the overlapping coverage region by using the position information generating unit 220 and/or measure the downlink beam (that is, the “next beam” indicated by the information about the next beam previously received from the network side as shown in FIG. 5) based on a measurement notification received from the network side-device. The measurement unit 230 may further generate a beam measurement report based on a beam measurement result at an appropriate time instant, and to transmit the beam measurement report to the network side-device by using the transceiver unit 210 for determining the using beam by the network side-device.

More specifically, in this example, the measurement unit 230 of the electronic device 200, which receives the second predetermined rule for determining a using beam or the third predetermined rule for determining a using beam, may be configured to: not perform beam measurement before the user equipment reaches the entry-side edge; and perform beam measurement for the next beam with the network side-device after the user equipment reaches the entry-side edge, generate a beam measurement result, and report, by using the transceiver unit 210, the beam measurement result to the network side-device for the network side-device to transmit data using one of or both the current beam and the next beam based on the beam measurement result. As an example, the measurement may be performed, for example, by the network side-device controlling (such as after transmitting an optional measurement notification to the electronic device 200) to continuously transmit the next beam B_{N} shown in FIG. 4 and the measurement unit 230 continuously measuring the beam quality of the next beam (for example, the measurement unit 230 may receive and measure the downlink beam based on time-frequency resources and the beam direction indicated by the measurement notification), which is not repeated herein.

For example, in a case that the electronic device 200 receives the second predetermined rule for determining a using beam (using both the current beam and the next beam in a case that the beam measurement result for the next beam is higher than the first threshold for the first time period after the user equipment reaches the entry-side edge of the overlapping coverage region), in the beam measurement for the next beam (such as the next beam B_{N} shown in FIG. 4), the measurement unit 230 of the electronic device 200 may further generate a first measurement result report in a case that the beam measurement result of the next beam is higher than a first threshold for a first time period, and transmit the first measurement result report to the network side-device by using the transceiver unit 210. In addition, the transceiver unit 210 of the electronic device 200 may receive data transmitted from the network side-device using both the current beam and the next beam.

Alternatively or additionally, for example, in a case that the electronic device 200 receives the third predetermined rule for determining a using beam (using only the next beam if the beam measurement result of the next beam is higher than a second threshold for a second time period after the user equipment reaches the entry-side edge of the overlapping coverage region), the measurement unit 230 of the electronic device 200 may further generate a second measurement result report in a case that the beam measurement result of the next beam is higher than a second threshold for a second time period, and transmit the second measurement result report to the network side-device by using the transceiver unit 210. In addition, the transceiver unit 210 of the electronic device 200 may receive data transmitted from the network side-device only using the next beam. Preferably, the second threshold is higher than the first threshold and/or the second time period is longer than the first time period.

As an example, the processes, in which the electronic device 200 receives data transmitted from the network side-device by using different beams based on the relationship between the position of the user equipment and the edge of the overlapping coverage region and based on the beam measurement result, may be performed through the exemplary information exchange described above with reference to FIG. 8 and/or FIG. 9. That is, the electronic device 200 used for the user equipment may perform all the functions or processes of the UE in the exemplary interactions described with reference to FIG. 8 and/or FIG. 9 by using the transceiver unit 210, the position information generating unit 220 and the measurement unit 230, which is not repeated herein.

In another example, for example, according to the fourth predetermined rule for determining a using beam (using both the current beam and the next beam when the user equipment reaches the entry-side edge of the overlapping coverage region, and using the next beam when the user equipment reaches the exit-side edge), the network side-device may determine the using beam only based on the position of the user equipment reaching the edge of the overlapping coverage region, without performing beam measurement.

Correspondingly, in this example, in a case of receiving the fourth predetermined rule for determining a using beam, when no beam measurement is performed, the electronic device 200 may receive, after the position of the user equipment reaches the entry-side edge, data transmitted from the network side-device by using both the current beam and the next beam, for example, by using the transceiver unit 210; and/or receive, after the position of the user equipment reaches the exit-side edge, data transmitted from the network side-device by only using the next beam, for example, by using the transceiver unit 210.

As an example, the processes, in which the electronic device 200 receives data transmitted from the network side-device by using different beams only based on the relationship between the position of the user equipment and the edge of the overlapping coverage region, may be performed through the exemplary information exchange described above with reference to FIG. 10. That is, the electronic device 200 used for the user equipment may perform all the functions or processes of the UE in the exemplary interactions described with reference to FIG. 10 by using the transceiver unit 210, the position information generating unit 220 and the measurement unit 230, which is not repeated herein.

In the above example in which the network side-device determines the using beam according to the second predetermined rule, the third predetermined rule or the fourth predetermined rule and the electronic device 200 receives information about the second predetermined rule, the third predetermined rule or the fourth predetermined rule transmitted by the network side-device (for example, provided together with the information about the current beam, the information about the next beam, and the information about the edge of the overlapping coverage region in FIG. 5), the electronic device 200 may know the downlink beam actually used by the base station side according to a corresponding rule without real-time notification from the base station. The electronic device 200 knowing the actually used downlink beam is beneficial for the transceiver unit 210 of the electronic device 200 to receive downlink data using the corresponding beam.

For example, in a scenario in which the second predetermined rule or the third predetermined rule is used, while the measurement unit 230 generates a corresponding first measurement result report or a second measurement result report, the electronic device 200 determines the downlink beam actually used by the base station side being the “current beam” and the “next beam” indicated by the previously received information about the current beam and the information about the next beam, or the “next beam” indicated by the previously received information about the next beam. In a scenario in which the fourth predetermined rule is used, the electronic device 200 may determine the actually used beam based on the position of the user equipment monitored by the position information generating unit 220.

In addition, alternatively or optionally, the electronic device 200 may receive a beam indication for the actual using beam that is transmitted from the network side-device before the network side-device performs data transmission using a changed beam, so that the electronic device 200 determines the actual using beam, which is not repeated herein.

In addition, in the above example of the third predetermined rule or the fourth predetermined rule, in a case that downlink data transmission is performing only using the next beam, it is considered that the user equipment has entered the coverage region of the next beam and performed beam switching, so the next beam may be set to be a new current beam. Optionally, the network side-device may then perform the process of determining the position of the user equipment, the current beam and the next beam and the process of determining the edge of the overlapping coverage region in a manner similar to the manner described above. Optionally, the network side-device may determine the position of the user equipment based on the position information reported by the user equipment and/or the information about the predetermined movement path of the transportation vehicle where the user equipment is located in a manner similar to the manner described above, or directly determine the position of the user equipment as the predicted position on the exit-side edge (such as the predicted exit position P2 shown in FIG. 4). The network side-device may directly determine the current beam of the user equipment based on the beam switching (for example, the previous next beam B_{N} shown in FIG. 4 is set to be a new current beam B_{C}), and may determine the next beam of the user equipment and the edge of the overlapping coverage region in a manner similar to the manner described above. Optionally, the electronic device 200 may receive the information determined in the above manners from network side-device for subsequent use, which is not repeated herein.

The electronic device 200 at the user side according to the embodiments of the present disclosure is described above. Through the interactions between the electronic device 200 and the network side-device (the base station side device), data transmission may be performed using an appropriate downlink beam based on a relationship between the position of the user equipment and the overlapping coverage region, thereby reducing dependence on beam measurement.

### 4. CONFIGURATION EXAMPLES OF AN INFORMATION PROCESSING DEVICE IN A THIRD EMBODIMENT

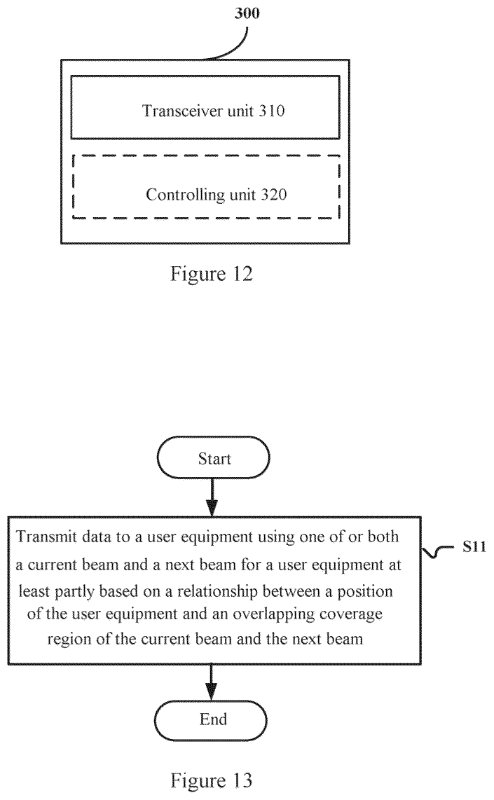

FIG. 12 is a block diagram showing a configuration example of an information processing device according to a third embodiment of the present disclosure. The information processing device may be configured to provide information about the predetermined movement path of the transportation vehicle where the user device is located for the base station side device in the first embodiment, and for example, the information processing device may be a server arranged in a core network or a cloud service platform.

As shown in FIG. 12, an information processing device 300 may include a transceiver unit 310 and an optional controlling unit 320. The transceiver unit 310 may, for example, transmit information to an external device of the information processing device 300 and/or receive information from an external device of the information processing device 300.

In addition, although not shown in the FIG. 12, the information processing device 300 may further include a storage unit.

All the units of the information processing device 300 may be included in processing circuitry. It should be noted that the information processing device 300 may include one processing circuitry or multiple processing circuitry. Further, the processing circuitry may include various discrete functional units to perform various functions and/or operations. It should be noted that the functional units may be physical entities or logical entities, and units with different titles may be implemented by the same physical entity.

According to this embodiment, the transceiver unit 310 may transmit information about a predetermined movement path of a transportation vehicle to an electronic device for wireless communication (such as the electronic device 100 at the base station side according to the first embodiment), so that the electronic device determines a relationship between a position of a user equipment (such as the electronic device 200 at the user side according to the second embodiment) on the transportation vehicle and an edge of an overlapping coverage region of a current beam and a next beam for the user equipment at least partially based on the information, so as to transmit data to the user equipment using one of or both the current beam and the next beam.

The information about the predetermined movement path of the transportation vehicle, for example, may include information indicating: an identifier (ID) of the transportation vehicle and/or a number of the movement path (such as flight number/train number), a geographic position (and an optional altitude) along the movement path, and time associated with the geographic position (and the optional altitude) along the movement path. Optionally, the information may further include information indicating a movement direction (associated with the geographic position (and the optional altitude) along the movement path and the time).

The information processing device 300 may, for example, obtain information about the predetermined movement path of the transportation vehicle through various appropriate means. For example, the information processing device 300 may regularly or periodically obtain information about the predetermined movement path of the transportation vehicle from the operator of the transportation vehicle (such as airlines, railway companies, automobile companies and shipping companies) or other relevant parties through the transceiver unit 310 under the control of the controlling unit 320, and it may obtain updated information about the movement path of the transportation vehicle in real time.

The information processing device 300 may provide information about the predetermined movement path of the transportation vehicle to the electronic device at the base station side in various appropriate ways. For example, the information processing device 300 may transmit information about the predetermined movement path of the transportation vehicle to the electronic device at the base station side periodically, regularly (such as at a predetermined time instant before the transportation vehicle enters the coverage region of the electronic device at the base station side), or only when the movement path is updated, through the transceiver unit 310 under the control of the controlling unit 320.

The electronic devices and the information processing devices according to the first embodiment to the third embodiment of the present disclosure are described above. In a variant example of the present disclosure, a device, such as a proxy device or a relay node (such as an IAB nodes), may be arranged on the transportation vehicle, and the device may uniformly obtain information about the predetermined movement path of the transportation vehicle from the information processing device (such as a server at a core network or at a cloud service platform) in the third embodiment. Optionally, the device may forward the information about the predetermined movement path of the transportation vehicle to all the user equipments (for example, having some or all of the functions of the electronic devices in the second embodiment) on the transportation vehicle. In addition, instead of the user equipments on transportation vehicles generating and transmitting position information of the user equipments to the base station side device (for example, having some or all of the functions of the electronic devices in the third embodiment), the device may generate and transmit position information of the transportation vehicle to the base station side device for use. When appropriate, the device may further forward or relay other data and/or information between the base station side device and the user equipments on the transportation vehicle, which is not repeated herein.

### 5. METHOD EMBODIMENTS

Corresponding to the above device embodiments, the following method embodiments are provided according to the present disclosure.

### Method Embodiments of the First Embodiment

FIG. 13 is a flowchart showing an exemplary process of a method for wireless communication at a base station side according to the first embodiment of the present disclosure.

As shown in FIG. 13, in step S11, data is transmitted to a user equipment using one of or both a current beam and a next beam for a user equipment at least partly based on a relationship between a position of the user equipment and an overlapping coverage region of the current beam and the next beam. The overlapping coverage region may, for example, have an entry-side edge for the user equipment to enter the overlapping coverage region and an exit-side edge for the user equipment to leave the overlapping coverage region.

Although not shown in the FIG. 13, the step S11 may, for example, include the following processing: not performing beam measurement with the user equipment before the user equipment reaches the entry-side edge; and performing beam measurement for the next beam with the user equipment after the user equipment reaches the entry-side edge, receiving a beam measurement result from the user equipment, and transmitting the data to the user equipment using one of or both the current beam and the next beam based on the beam measurement result.

In one example, the step S11 may further include: receiving a first measurement result report that is transmitted from the user equipment in a case that the beam measurement result of the next beam is higher than a first threshold for a first time period, and transmitting the data to the user equipment using both the current beam and the next beam based on the first measurement result report. Additionally or alternatively, the step S11 may further include: receiving a second measurement result report that is transmitted from the user equipment in a case that the beam measurement result of the next beam is higher than a second threshold for a second time period, and transmitting the data to the user equipment only using the next beam based on the second measurement result report.

In another example, the step S11 may further include performing the following processing in a case of not performing beam measurement with the user equipment: after the user equipment reaches the entry-side edge, transmitting the data to the user equipment using both the current beam and the next beam; and/or after the user equipment reaches the exit-side edge, transmitting the data to the user equipment only using the next beam.

In a preferred example, the user equipment is on a transportation vehicle with a predetermined movement path. In this example, although not shown in FIG. 13, the step S11 may, for example, include the following processing: obtaining information about the predetermined movement path from another device; and determining the position, the current beam and the next beam of the user equipment at least partly based on the information about the predetermined movement path.

Optionally, the step S11 may further include: providing the user equipment with information about the current beam, information about the next beam, and information about an edge of the overlapping coverage region. For example, the information about the edge of the overlapping coverage region may indicate at least one of: a position of the edge; and a predicted position of the user equipment reaching the edge that is determined based on the predetermined movement path and the position of the edge.

Optionally, in a case that the information about the edge of the overlapping coverage region indicates the position of the edge, the step S11 may further include: receiving a deviation report that is transmitted from the user equipment when an actual position of the user equipment reaching the edge is inconsistent with the predicted position and that indicates the inconsistency. Optionally, the step S11 may further include: determining the position, the current beam and the next beam of the user equipment with reference to the deviation report.

As an example, the exemplary method shown in FIG. 13 may be performed by a base station in a non-terrestrial network, and in step S11, the current beam and the next beam of the user equipment may be determined based on a ephemeris of a satellite that is used for transmitting a downlink beam and controlled by the base station in the non-terrestrial network. In addition, optionally, the step S11 may further include: starting a timer after the user equipment accesses to the base station in the non-terrestrial network; after the timer expires, determining whether the ephemeris and/or the geographic position of the satellite controlled by the base station in the non-terrestrial network is updated; in a case that the ephemeris and/or a geographic position is updated, determining the current beam and the next beam of the user equipment based on the updated ephemeris and/or geographic position.

According to the embodiments of the present disclosure, the subject performing the above method may be the electronic device at the base station side according to the first embodiment of the present disclosure. Therefore, all the embodiments of the electronic device at the base station side mentioned above are applicable, and are not repeated herein.

### Method Embodiments of the Second Embodiment

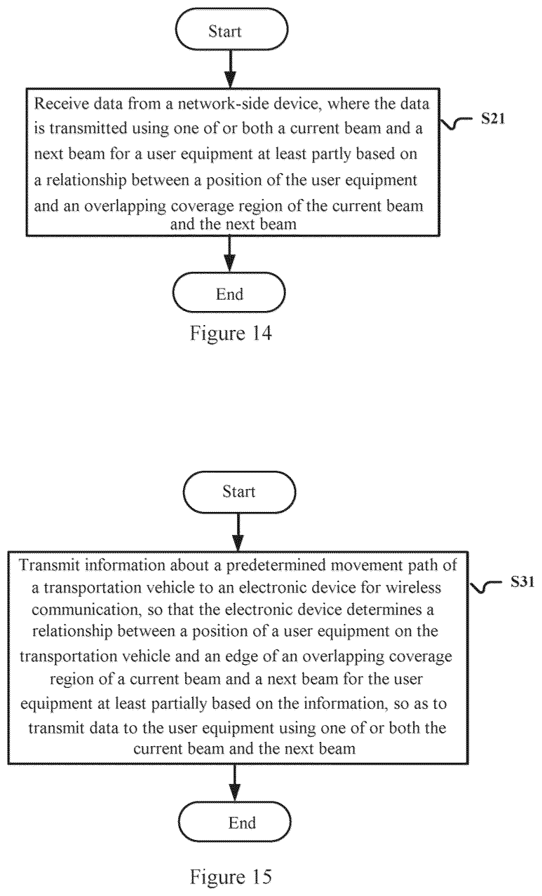

FIG. 14 is a flowchart showing an exemplary process of a method for wireless communication at a user equipment side according to the second embodiment of the present disclosure.

As shown in FIG. 14, in step S21, data is received from a network-side device, where the data is transmitted using one of or both a current beam and a next beam for a user equipment at least partly based on a relationship between a position of the user equipment and an overlapping coverage region of the current beam and the next beam. The overlapping coverage region may, for example, have an entry-side edge for the user equipment to enter the overlapping coverage region and an exit-side edge for the user equipment to leave the overlapping coverage region.

Although not shown in FIG. 14, the step S21 may, for example, further include the following processing: not performing beam measurement before the user equipment reaches the entry-side edge; and performing beam measurement for the next beam with the network-side device after the user equipment reaches the entry-side edge, and reporting a beam measurement result to the network-side device for the network-side device to transmit the data using one of or both the current beam and the next beam based on the beam measurement result.

In an example, the step S21 may further include: in a case that the beam measurement result of the next beam is higher than a first threshold for a first time period, transmitting a first measurement result report to the network-side device, and receiving the data transmitted from the network-side device using both the current beam and the next beam. Additionally or alternatively, the step S21 may further include: in a case that the beam measurement result of the next beam is higher than a second threshold for a second time period, transmitting a second measurement result report to the network-side device, and receiving the data transmitted from the network-side device only using the next beam.

In another example, the step S21 may further include performing the following processing in a case of not performing beam measurement: after the user equipment reaches the entry-side edge, receiving the data transmitted from the network-side device using both the current beam and the next beam; and/or after the user equipment reaches the exit-side edge, receiving the data transmitted from the network-side device only using the next beam.

In a preferred example, the user equipment is on a transportation vehicle with a predetermined movement path. In this example, although not shown in FIG. 14, the step S21 may, for example, include the following processing: obtaining information about the current beam, information about the next beam, and information about an edge of the overlapping coverage region from the network-side device. For example, the information about the edge of the overlapping coverage region may indicate at least one of: a position of the edge; and a predicted position of the user equipment reaching the edge that is determined based on the predetermined movement path and the position of the edge.

Optionally, in a case that the information about the edge of the overlapping coverage region indicates the position of the edge, the step S21 may further include: transmitting, when an actual position of the user equipment reaching the edge is inconsistent with the predicted position, a deviation report indicating the inconsistency to the network-side device.

According to the embodiments of the present disclosure, the subject performing the above method may be the electronic device at the user equipment side according to the second embodiment of the present disclosure. Therefore, all the embodiments of the electronic device at the user equipment side mentioned above are applicable, and are not repeated herein.

### Method Embodiments of the Third Embodiment

FIG. 15 is a flowchart showing an exemplary process of an information processing method according to the third embodiment of the present disclosure.

As shown in FIG. 15, in step S31, information about a predetermined movement path of a transportation vehicle is transmitted to an electronic device for wireless communication, so that the electronic device determines a relationship between a position of a user equipment on the transportation vehicle and an edge of an overlapping coverage region of a current beam and a next beam for the user equipment at least partially based on the information, so as to transmit data to the user equipment using one of or both the current beam and the next beam.

According to the embodiments of the present disclosure, the subject performing the above method may be the information processing device according to the third embodiment of the present disclosure. Therefore, all the embodiments of the electronic device at the user equipment side mentioned above are applicable, and are not repeated herein.

### 6. APPLICATION EXAMPLES

The technology according to the present disclosure may be applicable to various products.

For example, the electronic device 100 in the first embodiment may be implemented at a base station side. In a case that the electronic device is implemented at a base station side, the electronic device may be implemented as various base stations, such as a macro eNB and a small eNB, and may be implemented as any type of gNB (a base station in a 5G system). The small eNB may be an eNB, such as a pico eNB, a micro eNB, and a home (femto) eNB, which covers a cell smaller than a macro cell. Alternatively, the base station may be implemented as any other type of base station, such as a NodeB and a base transceiver station (BTS). The base station may include: a body (which is also referred to as a base station device) configured to control wireless communications, and one or more remote wireless heads (RRHs) arranged in a different place from the body.

The electronic device 100 in the first embodiment may further be implemented as various TRPs. The TRPs may have transmitting and receiving functions, such as receiving information from a user equipment and a base station device and transmitting information to a user equipment and a base station device. In a typical example, the TRPs may provide services to a user equipment and is controlled by a base station device. Furthermore, the TRPs may have a structure similar to the structure of the base station device, or the TRPs may only have a structure related to transmitting and receiving information in the base station device.

In addition, the electronic device 200 in the second embodiment may be implemented at a user equipment side. In a case that the electronic device is implemented at a user equipment side, for example, is implemented as a user equipment, the electronic device may be implemented as various user equipments. The user equipment may be implemented as a mobile terminal (such as a smart phone, a tablet personal computer (PC), a notebook PC, a portable game terminal, a portable/dongle type mobile router, and a digital camera) or a vehicle-mounted terminal (such as an automobile navigation device). The user equipment may also be implemented as a terminal (also referred to as a machine type communication (MTC) terminal) that performs machine-to-machine (M2M) communication. In addition, the user equipment may be a wireless communication module (such as an integrated circuit module including a single chip) installed on each of the above-mentioned user equipments.

In addition, the information processing device 300 in the third embodiment may be implemented by a server at a core network side or a server at a cloud service platform. The information processing device may be implemented as any types of control entities, for example, various types of servers, such as tower servers, rack servers, and blade servers. The information processing device may be a control module installed on a server (such as an integrated circuit module including a single chip, and a card or a blade inserted into a slot of a blade server).

### Application Examples of a Control Entity

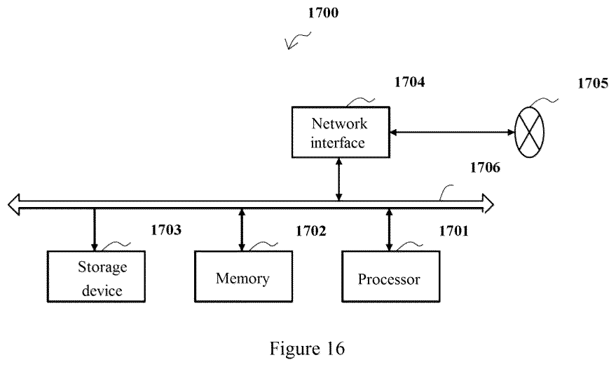

FIG. 16 is a block diagram showing an example of a schematic configuration of a server 1700 to which the technology of the present disclosure may be applied. The server 1700 includes a processor 1701, a memory 1702, a storage device 1703, a network interface 1704, and a bus 1706.

The processor 1701 may be, for example, a central processing unit (CPU) or a digital signal processor (DSP), and controls functions of the server 1700. The memory 102 includes a random access memory (RAM) and a read-only memory (ROM), and stores data and a program that is executed by the processor 1701. The storage device 1703 may include a storage medium, such as a semiconductor memory and a hard disk.

The network interface 1704 is a wired communication interface for connecting the server 1700 to a wired communication network 7105. The wired communication network 1705 may be a core network such as an evolved packet core network (EPC) or a packet data network (PDN) such as the Internet.

The bus 1706 connects the processor 1701, the memory 1702, the storage device 1703 and the network interface 1704 to each other. The bus 1706 may include two or more buses having different speed respectively (such as a high speed bus and a low speed bus).

In the server 1700 shown in FIG. 16, the controlling unit in the information processing device 300 in the third embodiment described with reference to FIG. 12 may be implemented by the processor 1701. For example, the processor 1701 may perform the functions of the controlling unit by executing instructions stored in the memory 1702 or in the storage device 1703. In addition, the transceiver unit in the information processing device 300 may be implemented through the network interface 1704 and the like.

### Application Examples of a Base Station

### First Application Example

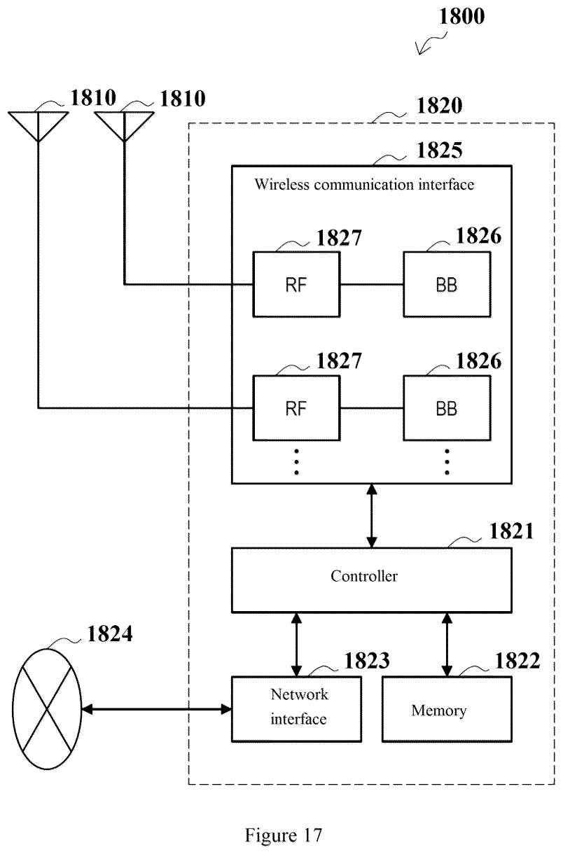

FIG. 17 is a block diagram showing a first example of a schematic configuration of an eNB to which the technology of the present disclosure may be applied. An eNB 1800 includes one or more antennas 1810 and a base station device 1820. The base station device 1820 and each of the antennas 1810 may be connected to each other via an RF cable.

Each of the antennas 1810 includes a single or multiple antenna elements (such as multiple antenna elements included in a multiple-input multiple-output (MIMO) antenna), and is used for the base station device 1820 to transmit and receive wireless signals. As shown in FIG. 17, the eNB 1800 may include multiple antennas 1810. For example, the multiple antennas 1810 may be compatible with multiple frequency bands used by the CNB 1800. Although FIG. 17 shows an example in which the eNB 1800 includes multiple antennas 1810, the eNB 1800 may also include a single antenna 1810.

The base station device 1820 includes a controller 1821, a memory 1822, a network interface 1823, and a wireless communication interface 1825.

The controller 1821 may be, for example, a CPU or a DSP, and manipulate various functions of a higher layer of the base station device 1820. For example, the controller 1821 generates a data packet based on data in a signal processed by the wireless communication interface 1825, and transmits the generated packet via the network interface 1823. The controller 1821 may bundle data from multiple baseband processors to generate a bundled packet, and transfer the generated bundled packet. The controller 1821 may have a logical function for performing control such as radio resource control, radio bearer control, mobility management, admission control, and scheduling. This control may be executed in conjunction with nearby eNBs or core network nodes. The memory 1822 includes an RAM and an ROM, and stores programs executed by the controller 1821 and various types of control data (such as a terminal list, transmission power data, and scheduling data).

The network interface 1823 is a communication interface for connecting the base station device 1820 to a core network 1824. The controller 1821 may communicate with a core network node or another eNB via the network interface 1823. In this case, the eNB 1800 and the core network node or other eNBs may be connected to each other through a logical interface (such as an SI interface and an X2 interface). The network interface 1823 may also be a wired communication interface, or a wireless communication interface for a wireless backhaul line. If the network interface 1823 is a wireless communication interface, the network interface 1823 may use a higher frequency band for wireless communications than the frequency band used by the wireless communication interface 1825.

The wireless communication interface 1825 supports any cellular communication scheme (such as Long Term Evolution (LTE) and LTE-Advanced), and provides wireless connection to a terminal located in a cell of the eNB 1800 via an antenna 1810. The wireless communication interface 1825 may generally include, for example, a baseband (BB) processor 1826 and an RF circuit 1827. The BB processor 1826 may perform, for example, encoding/decoding, modulation/demodulation, and multiplexing/demultiplexing, and perform various types of signal processing of layers (such as LI, medium access control (MAC), radio link control (RLC), and packet data convergence protocol (PDCP)). Instead of the controller 1821, the BB processor 1826 may have a part or all of the above-mentioned logical functions. The BB processor 1826 may be a memory storing a communication control program, or a module including a processor and related circuits configured to execute the program. The function of the BB processor 1826 may be changed by updating the program. The module may be a card or a blade inserted into a slot of the base station device 1820. Alternatively, the module may be a chip mounted on a card or blade. Meanwhile, the RF circuit 1827 may include, for example, a mixer, a filter, and an amplifier, and transmit and receive a wireless signal via the antenna 1810.

As shown in FIG. 17, the wireless communication interface 1825 may include multiple BB processors 1826. For example, the multiple BB processors 1826 may be compatible with multiple frequency bands used by the eNB 1800. As shown in FIG. 17, the wireless communication interface 1825 may include multiple RF circuits 1827. For example, the multiple RF circuits 1827 may be compatible with multiple antenna elements. Although FIG. 17 shows an example in which the wireless communication interface 1825 includes multiple BB processors 1826 and multiple RF circuits 1827, the wireless communication interface 1825 may also include a single BB processor 1826 or a single RF circuit 1827.

In the eNB 1800 shown in FIG. 17, the functions of the controlling unit 110 in the electronic device 100 described with reference to FIG. 2 may be implemented by the controller 1821 (optionally and some modules in the wireless communication interface 1825). For example, the controller 1821 may perform functions or at least some functions of corresponding units by executing instructions stored in the memory 1822. The transceiver unit 120 in the electronic device 100 may be implemented by the wireless communication interface 1825 (for example, under the control of the controller 1821).

### Second Application Example

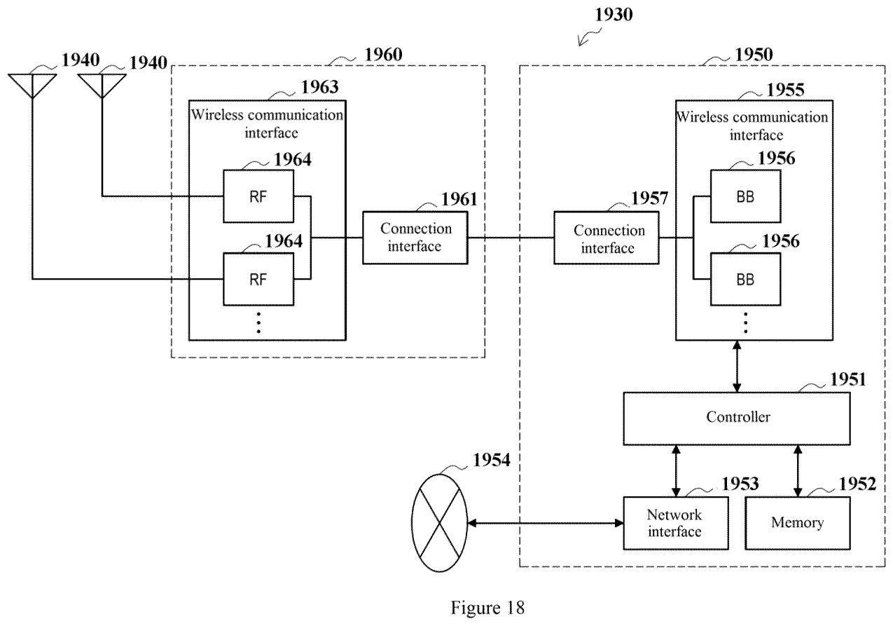

FIG. 18 is a block diagram showing a second example of a schematic configuration of an eNB to which the technology of the present disclosure may be applied. An eNB 1930 includes one or more antennas 1940, a base station device 1950, and an RRH 1960. The RRH 1960 and each antenna 1940 may be connected to each other via an RF cable. The base station device 1950 and the RRH 1960 may be connected to each other via a high-speed line such as an optical fiber cable.

Each of the antennas 1940 includes a single or multiple antenna elements (such as multiple antenna elements included in a MIMO antenna) and is used for the RRH 1960 to transmit and receive a wireless signal. As shown in FIG. 18, the eNB 1930 may include multiple antennas 1940. For example, the multiple antennas 1940 may be compatible with multiple frequency bands used by the eNB 1930. Although FIG. 18 shows an example in which the eNB 1930 includes multiple antennas 1940, the eNB 1930 may also include a single antenna 1940.

The base station device 1950 includes a controller 1951, a memory 1952, a network interface 1953, a wireless communication interface 1955, and a connection interface 1957. The controller 1951, the memory 1952, and the network interface 1953 are the same as the controller 1821, the memory 1822, and the network interface 1823 as described with reference to FIG. 17.

The wireless communication interface 1955 supports any cellular communication scheme (such as LTE and LTE-Advanced), and provides wireless communications to a terminal located in a sector corresponding to the RRH 1960 via the RRH 1960 and the antenna 1940. The wireless communication interface 1955 may generally include, for example, a BB processor 1956. The BB processor 1956 is the same as the BB processor 1826 described with reference to FIG. 17 except that the BB processor 1956 is connected to the RF circuit 1964 of the RRH 1960 via the connection interface 1957. As shown in FIG. 18, the wireless communication interface 1955 may include multiple BB processors 1956. For example, the multiple BB processors 1956 may be compatible with multiple frequency bands used by the eNB 1930. Although FIG. 18 shows an example in which the wireless communication interface 1955 includes multiple BB processors 1956, the wireless communication interface 1955 may also include a single BB processor 1956.

The connection interface 1957 is an interface for connecting the base station device 1950 (wireless communication interface 1955) to the RRH 1960. The connection interface 1957 may also be a communication module for communication in the above-mentioned high-speed line that connects the RRH 1960 to the base station device 1950 (wireless communication interface 1955).

The RRH 1960 includes a connection interface 1961 and a wireless communication interface 1963.

The connection interface 1961 is an interface for connecting the RRH 1960 (wireless communication interface 1963) to the base station device 1950. The connection interface 1961 may also be a communication module for communication in the above-mentioned high-speed line.

The wireless communication interface 1963 transmits and receives wireless signals via the antenna 1940. The wireless communication interface 1963 may generally include, for example, an RF circuit 1964. The RF circuit 1964 may include, for example, a mixer, a filter, and an amplifier, and transmit and receive wireless signals via the antenna 1940. As shown in FIG. 18, the wireless communication interface 1963 may include multiple RF circuits 1964. For example, the multiple RF circuits 1964 may support multiple antenna elements. Although

FIG. 18 shows an example in which the wireless communication interface 1963 includes multiple RF circuits 1964, the wireless communication interface 1963 may also include a single RF circuit 1964.

In the eNB 1930 shown in FIG. 18, the functions of the controlling unit 110 in the electronic device 100 described with reference to FIG. 2 may be implemented by the controller 1951 (optionally and the wireless communication interface 1955 and some modules in the wireless communication interface 1963). For example, the controller 1951 may perform functions or at least some functions of corresponding units by executing instructions stored in the memory 1952. The transceiver unit 120 in the electronic device 100 may be implemented by the wireless communication interface 1955 and the wireless communication interface 1963 (for example, under the control of the controller 1821).

### Application Examples of a User Equipment

### First Application Example

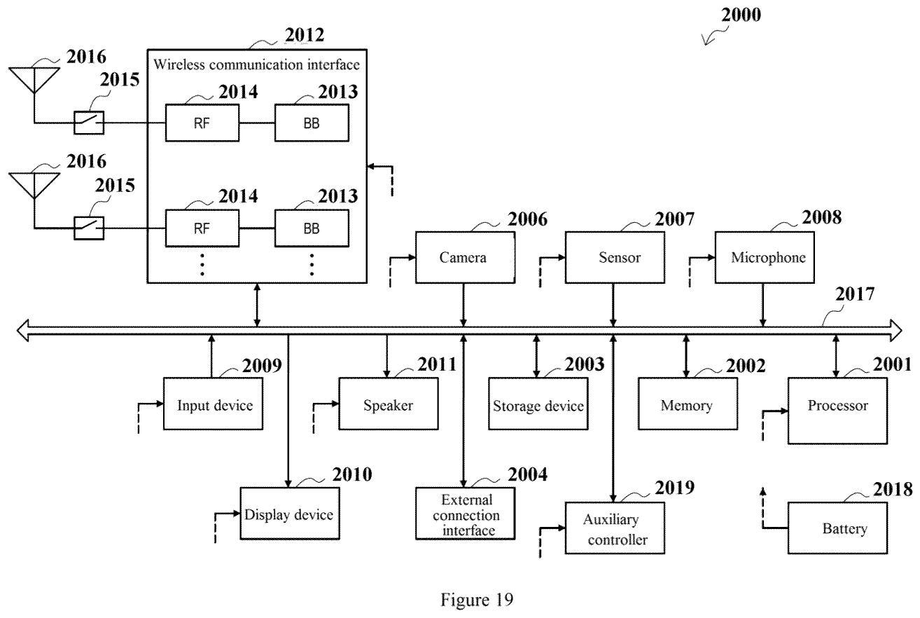

FIG. 19 is a block diagram showing an example of a schematic configuration of a smart phone 2000 to which the technology of the present disclosure may be applied. The smart phone 2000 includes a processor 2001, a memory 2002, a storage device 2003, an external connection interface 2004, a camera device 2006, a sensor 2007, a microphone 2008, an input device 2009, a display device 2010, a speaker 2011, a wireless communication interface 2012, one or more antenna switches 2015, one or more antennas 2016, a bus 2017, a battery 2018, and an auxiliary controller 2019.

The processor 2001 may be, for example, a CPU or a system on a chip (SoC), and controls the functions of the application layer and other layers of the smart phone 2000. The memory 2002 includes an RAM and an ROM, and stores data and programs executed by the processor 2001. The storage device 2003 may include a storage medium such as a semiconductor memory and a hard disk. The external connection interface 2004 is an interface for connecting an external device (such as a memory card and a universal serial bus (USB) device) to the smart phone 2000.

The camera device 2006 includes an image sensor (such as a charge coupled device (CCD) and a complementary metal oxide semiconductor (CMOS)), and generates a captured image. The sensor 2007 may include a group of sensors, such as a measurement sensor, a gyroscope sensor, a geomagnetic sensor, and an acceleration sensor. The microphone 2008 converts sound inputted to the smart phone 2000 into an audio signal. The input device 2009 includes, for example, a touch sensor, a keypad, a keyboard, a button, or a switch configured to detect a touch on a screen of the display device 2010, and receives an operation or information input from a user. The display device 2010 includes a screen (such as a liquid crystal display (LCD) and an organic light emitting diode (OLED) display), and displays an output image of the smart phone 2000. The speaker 2011 converts an audio signal outputted from the smart phone 2000 into sound.

The wireless communication interface 2012 supports any cellular communication scheme (such as LTE and LTE-Advanced), and performs wireless communication. The wireless communication interface 2012 may generally include, for example, a BB processor 2013 and an RF circuit 2014. The BB processor 2013 may perform, for example, encoding/decoding, modulation/demodulation, and multiplexing/demultiplexing, and perform various types of signal processing for wireless communications. Further, the RF circuit 2014 may include, for example, a mixer, a filter, and an amplifier, and transmit and receive wireless signals via the antenna 2016. The wireless communication interface 2012 may be a chip module on which the BB processor 2013 and the RF circuit 2014 are integrated. As shown in FIG. 19, the wireless communication interface 2012 may include multiple BB processors 2013 and multiple RF circuits 2014. Although FIG. 19 shows an example in which the wireless communication interface 2012 includes multiple BB processors 2013 and multiple RF circuits 2014, the wireless communication interface 2012 may also include a single BB processor 2013 or a single RF circuit 2014.

In addition to the cellular communication scheme, the wireless communication interface 2012 may support another type of wireless communication scheme, such as a short-range wireless communication scheme, a near field communication scheme, and a wireless local area network (LAN) scheme. In this case, the wireless communication interface 2012 may include a BB processor 2013 and an RF circuit 2014 for each wireless communication scheme.

Each of the antenna switches 2015 switches a connection destination of the antenna 916 among multiple circuits included in the wireless communication interface 2012 (for example, circuits for different wireless communication schemes).

Each of the antennas 2016 includes a single or multiple antenna elements (such as multiple antenna elements included in a MIMO antenna), and is used for the wireless communication interface 2012 to transmit and receive wireless signals. As shown in FIG. 19, the smart phone 2000 may include multiple antennas 2016. Although FIG. 19 shows an example in which the smart phone 2000 includes multiple antennas 2016, the smart phone 2000 may also include a single antenna 2016.

In addition, the smart phone 2000 may include an antenna 2016 for each wireless communication scheme. In this case, the antenna switch 2015 may be omitted from the configuration of the smart phone 2000.

The processor 2001, the memory 2002, the storage device 2003, the external connection interface 2004, the camera device 2006, the sensor 2007, the microphone 2008, the input device 2009, the display device 2010, the speaker 2011, the wireless communication interface 2012, and the auxiliary controller 2019 are connected to each other via the bus 2017. The battery 2018 supplies power to each block of the smart phone 2000 shown in FIG. 19 via a feeder line, and the feeder line is partially shown as a dashed line in the Figure. The auxiliary controller 2019, for example, operates the least necessary function of the smart phone 2000 in the sleep mode.

In the smart phone 2000 as shown in FIG. 19, the functions of the position information generating unit 220 and the measurement unit 230 in the electronic device 200 described with reference to FIG. 11 may be implemented by the controller 2001 or the auxiliary controller 2019 (and optionally some modules of the wireless communication interface 2012). For example, the controller 2001 or the auxiliary controller 2019 may perform all or part of the functions of the position information generating unit 220 and the measurement unit 230 by executing instructions stored in the memory 2002 or in the storage device 2003. The transceiver unit 210 in the electronic device 200 may be implemented by the wireless communication interface 2012 (for example, under the control of the controller 2001 or the auxiliary controller 2019).

### Second Application Example

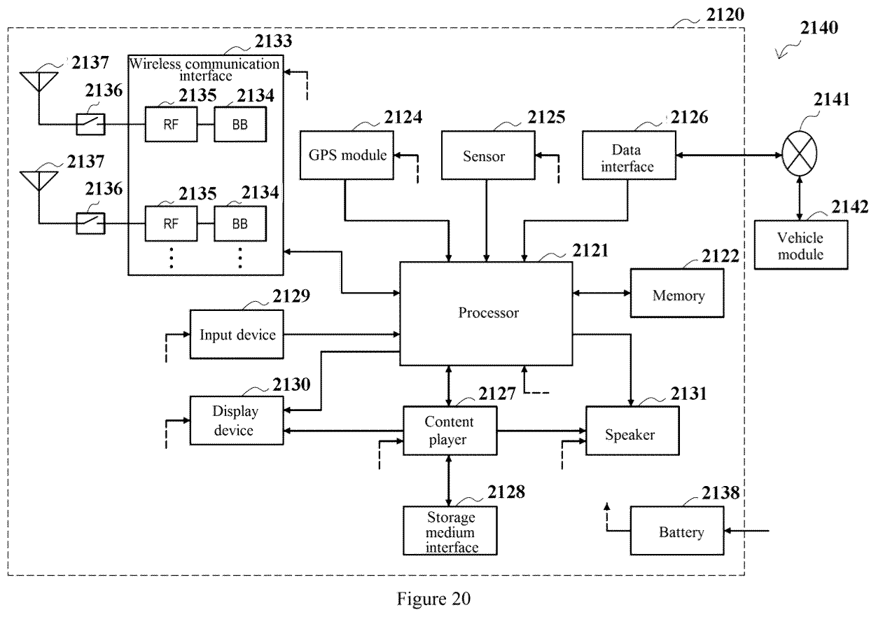

FIG. 20 is a block diagram showing an example of a schematic configuration of a vehicle navigation device 2120 to which the technology according to the present disclosure may be applied. The vehicle navigation device 2120 includes a processor 2121, a memory 2122, a global positioning system (GPS) module 2124, a sensor 2125, a data interface 2126, a content player 2127, a storage medium interface 2128, an input device 2129, a display device 2130, a speaker 2131, a wireless communication interface 2133, one or more antenna switches 2136, one or more antennas 2137, and a battery 2138.

The processor 2121 may be, for example, a CPU or a SoC, and controls the navigation function of the vehicle navigation device 2120 and other functions. The memory 2122 includes an RAM and an ROM, and stores data and programs executed by the processor 2121.

The GPS module 2124 measures a position (such as latitude, longitude, and altitude) of the vehicle navigation device 2120 based on a GPS signal received from a GPS satellite. The sensor 2125 may include a group of sensors, such as a gyroscope sensor, a geomagnetic sensor, and an air pressure sensor. The data interface 2126 is connected to, for example, an in-vehicle network 2141 via a terminal not shown, and acquires data (such as vehicle speed data) generated by the vehicle.

The content player 2127 reproduces content stored in a storage medium (such as CD and a DVD), which is inserted into the storage medium interface 2128. The input device 2129 includes, for example, a touch sensor, a button, or a switch configured to detect a touch on a screen of the display device 2130, and receives an operation or information input from the user. The display device 2130 includes a screen such as an LCD or OLED display, and displays an image of a navigation function or reproduced content. The speaker 2131 outputs the sound of the navigation function or the reproduced content.

The wireless communication interface 2133 supports any cellular communication scheme (such as LTE and LTE-Advanced), and performs wireless communication. The wireless communication interface 2133 may generally include, for example, a BB processor 2134 and an RF circuit 2135. The BB processor 2134 may perform, for example, encoding/decoding, modulation/demodulation, and multiplexing/demultiplexing, and perform various types of signal processing for wireless communication. Further, the RF circuit 2135 may include, for example, a mixer, a filter, and an amplifier, and transmit and receive wireless signals via the antenna 2137. The wireless communication interface 2133 may also be a chip module on which the BB processor 2134 and the RF circuit 2135 are integrated. As shown in FIG. 20, the wireless communication interface 2133 may include multiple BB processors 2134 and multiple RF circuits 2135. Although FIG. 20 shows an example in which the wireless communication interface 2133 includes multiple BB processors 2134 and multiple RF circuits 2135, the wireless communication interface 2133 may also include a single BB processor 2134 or a single RF circuit 2135.

In addition to the cellular communication scheme, the wireless communication interface 2133 may support other types of wireless communication schemes, such as a short-range wireless communication scheme, a near field communication scheme, and a wireless LAN scheme. In this case, the wireless communication interface 2133 may include a BB processor 2134 and an RF circuit 2135 for each wireless communication scheme.

Each of the antenna switches 2136 switches a connection destination of the antenna 2137 among multiple circuits included in the wireless communication interface 2133 (such as, circuits for different wireless communication schemes).

Each of the antennas 2137 includes a single or multiple antenna elements (such as multiple antenna elements included in a MIMO antenna), and is used for the wireless communication interface 2133 to transmit and receive wireless signals. As shown in FIG. 20, the vehicle navigation device 2120 may include multiple antennas 2137. Although FIG. 20 shows an example in which the vehicle navigation device 2120 includes multiple antennas 2137, the vehicle navigation device 2120 may also include a single antenna 2137.

In addition, the vehicle navigation device 2120 may include an antenna 2137 for each wireless communication scheme. In this case, the antenna switch 2136 may be omitted from the configuration of the vehicle navigation device 2120.

The battery 2138 supplies power to each block of the vehicle navigation device 2120 as shown in FIG. 20 via a feeder line, and the feeder line is partially shown as a dashed line in the Figure. The battery 2138 accumulates electric power supplied from the vehicle.

In the vehicle navigation device 2120 shown in FIG. 20, the functions of the position information generating unit 220 and the measurement unit 230 in the electronic device 200 described with reference to FIG. 11 may be implemented by the controller 2121 (and optionally some modules of the wireless communication interface 2133). For example, the controller 2121 may perform all or part of the functions of the position information generating unit 220 and the measurement unit 230 by executing instructions stored in the memory 2122. The transceiver unit 210 in the electronic device 200 may be implemented by the wireless communication interface 2133 (for example, under the control of the controller 2121).

The technology of the present disclosure may also be implemented as an in-vehicle system (or vehicle) 2140 including one or more blocks in a vehicle navigation device 2120, the in-vehicle network 2141, and the vehicle module 2142. The vehicle module 2142 generates vehicle data (such as vehicle speed, engine speed, and failure information), and outputs the generated data to the in-vehicle network 2141.

The preferred embodiments of the present disclosure have been described above with reference to the accompanying drawings. Apparently, the present disclosure is not limited to the above embodiments. Those skilled in the art may obtain various changes and modifications within the scope of the appended claims, and it should be understood that these changes and modifications are fall within the technical scope of the present disclosure.

For example, the units shown in dashed boxes in the functional block diagrams shown in the drawings indicate that the functional units are optional in the corresponding device, and the various optional functional units may be combined in an appropriate manner to perform required functions.

For example, the functions included in one unit according to the above embodiments may be realized by separate devices. Alternatively, the functions implemented by multiple units in the above embodiments may be implemented by separate devices, respectively. In addition, one of the above functions may be implemented by multiple units. It should be understood that the above configurations are included in the technical scope of the present disclosure.

In this specification, the steps described in the flowchart may be performed in the chronological order described herein, and may be performed in parallel or independently rather than necessarily in the chronological order. In addition, the chronological order in which the steps are performed may be changed appropriately.

In addition, the present disclosure may have the following configurations.

1. An electronic device for wireless communication, comprising:
processing circuitry, configured to:
receive data from a network-side device, wherein the data is transmitted using one of or both a current beam and a next beam for a user equipment at least partly based on a relationship between a position of the user equipment and an overlapping coverage region of the current beam and the next beam.

2. The electronic device according to configuration 1, wherein the overlapping coverage region has an entry-side edge for the user equipment to enter the overlapping coverage region and an exit-side edge for the user equipment to leave the overlapping coverage region.

3. The electronic device according to configuration 2, wherein the processing circuitry is further configured to:
not perform beam measurement before the user equipment reaches the entry-side edge; and
perform beam measurement for the next beam with the network-side device after the user equipment reaches the entry-side edge, and report a beam measurement result to the network-side device for the network-side device to transmit the data using one of or both the current beam and the next beam based on the beam measurement result.

4. The electronic device according to configuration 3, wherein the processing circuitry is further configured to:
in a case that the beam measurement result of the next beam is higher than a first threshold for a first time period, transmit a first measurement result report to the network-side device, and receive the data transmitted from the network-side device using both the current beam and the next beam.

5. The electronic device according to configuration 3 or 4, wherein the processing circuitry is further configured to:
in a case that the beam measurement result of the next beam is higher than a second threshold for a second time period, transmit a second measurement result report to the network-side device, and receive the data transmitted from the network-side device only using the next beam.

6. The electronic device according to configuration 2, wherein the processing circuitry is further configured to:
in a case of not performing beam measurement,
after the user equipment reaches the entry-side edge, receive the data transmitted from the network-side device using both the current beam and the next beam; and/or
after the user equipment reaches the exit-side edge, receive the data transmitted from the network-side device only using the next beam.

7. The electronic device according to configuration 1, wherein the user equipment is on a transportation vehicle with a predetermined movement path.

8. The electronic device according to configuration 7, wherein the processing circuitry is further configured to:
obtain information about the current beam, information about the next beam, and information about an edge of the overlapping coverage region from the network-side device.

9. The electronic device according to configuration 8, wherein the information about the edge of the overlapping coverage region indicates at least one of:
a position of the edge; and
a predicted position of the user equipment reaching the edge that is determined based on the predetermined movement path and the position of the edge.

10. The electronic device according to configuration 9, wherein in a case that the information about the edge of the overlapping coverage region indicates the position of the edge, the processing circuitry is further configured to:
transmit, when an actual position of the user equipment reaching the edge is inconsistent with the predicted position, a deviation report indicating the inconsistency to the network-side device.

11. An electronic device for wireless communication, comprising:
processing circuitry, configured to:
transmit data to a user equipment using one of or both a current beam and a next beam for the user equipment at least partly based on a relationship between a position of the user equipment and an overlapping coverage region of the current beam and the next beam.

12. The electronic device according to configuration 11, wherein the overlapping coverage region has an entry-side edge for the user equipment to enter the overlapping coverage region and an exit-side edge for the user equipment to leave the overlapping coverage region.

13. The electronic device according to configuration 12, wherein the processing circuitry is further configured to:
not perform beam measurement with the user equipment before the user equipment reaches the entry-side edge; and
performs beam measurement for the next beam with the user equipment after the user equipment reaches the entry-side edge, receive a beam measurement result from the user equipment, and transmit the data to the user equipment using one of or both the current beam and the next beam based on the beam measurement result.

14. The electronic device according to configuration 13, wherein the processing circuitry is further configured to:
receive a first measurement result report that is transmitted from the user equipment in a case that the beam measurement result of the next beam is higher than a first threshold for a first time period, and transmit the data to the user equipment using both the current beam and the next beam based on the first measurement result report.

15. The electronic device according to configuration 13 or 14, wherein the processing circuitry is further configured to:
receive a second measurement result report that is transmitted from the user equipment in a case that the beam measurement result of the next beam is higher than a second threshold for a second time period, and transmit the data to the user equipment only using the next beam based on the second measurement result report.

16. The electronic device according to configuration 12, wherein the processing circuitry is further configured to:
in a case of not performing beam measurement with the user equipment,
after the user equipment reaches the entry-side edge, transmit the data to the user equipment using both the current beam and the next beam; and/or
after the user equipment reaches the exit-side edge, transmit the data to the user equipment only using the next beam.

17. The electronic device according to configuration 11, wherein the user equipment is on a transportation vehicle with a predetermined movement path, and the processing circuitry is further configured to:
obtain information about the predetermined movement path from another device; and
determine the position, the current beam and the next beam of the user equipment at least partly based on the information about the predetermined movement path.

18. The electronic device according to configuration 17, wherein the processing circuitry is further configured to:
provide the user equipment with information about the current beam, information about the next beam, and information about an edge of the overlapping coverage region.

19. The electronic device according to configuration 18, wherein the information about the edge of the overlapping coverage region indicates at least one of:
a position of the edge; and
a predicted position of the user equipment reaching the edge that is determined based on the predetermined movement path and the position of the edge.

20. The electronic device according to configuration 19, wherein in a case that the information about the edge of the overlapping coverage region indicates the position of the edge, the processing circuitry is further configured to:
receive a deviation report that is transmitted from the user equipment when an actual position of the user equipment reaching the edge is inconsistent with the predicted position and that indicates the inconsistency.

21. The electronic device according to configuration 20, wherein the processing circuitry is further configured to:
determine the position, the current beam and the next beam of the user equipment with reference to the deviation report.

22. The electronic device according to configuration 17, wherein the electronic device comprises a base station in a non-terrestrial network, and the processing circuitry is further configured to:
determine the current beam and the next beam of the user equipment based on a ephemeris of a satellite that is used for transmitting a downlink beam and controlled by the base station in the non-terrestrial network.

23. The electronic device according to configuration 22, wherein the processing circuitry is further configured to:
start a timer after the user equipment accesses to the base station in the non-terrestrial network;
after the timer expires, determine whether the ephemeris and/or a geographic position of the satellite controlled by the base station in the non-terrestrial network is updated;
in a case that the ephemeris and/or the geographic position is updated, determine the current beam and the next beam of the user equipment based on the updated ephemeris and/or geographic position.

24. An information processing device, comprising:
processing circuitry, configured to:
transmit information about a predetermined movement path of a transportation vehicle to an electronic device for wireless communication, so that the electronic device determines a relationship between a position of a user equipment on the transportation vehicle and an edge of an overlapping coverage region of a current beam and a next beam for the user equipment at least partially based on the information, so as to transmit data to the user equipment using one of or both the current beam and the next beam.

25. A method for wireless communication, comprising:
receiving data from a network-side device, wherein the data is transmitted using one of or both a current beam and a next beam for a user equipment at least partly based on a relationship between a position of the user equipment and an overlapping coverage region of the current beam and the next beam.

26. A method for wireless communication, comprising:
transmitting data to a user equipment using one of or both a current beam and a next beam for the user equipment at least partly based on a relationship between a position of the user equipment and an overlapping coverage region of the current beam and the next beam.

27. An information processing method, comprising:
transmitting information about a predetermined movement path of a transportation vehicle to an electronic device for wireless communication, so that the electronic device determines a relationship between a position of a user equipment on the transportation vehicle and an edge of an overlapping coverage region of a current beam and a next beam for the user equipment at least partially based on the information, so as to transmit data to the user equipment using one of or both the current beam and the next beam.

28. A non-transitory computer-readable storage medium having a program stored thereon, wherein the program, when executed by a processor, causes the processor to perform the method according to any one of configurations 25 to 27.

Although the embodiments of the present disclosure have been described above in detail in connection with the drawings, it should be appreciated that the embodiments described above are merely illustrative rather than limitative of the present disclosure. Those skilled in the art can make various modifications and variations to the above embodiments without departing from the spirit and scope of the present disclosure. Therefore, the scope of the present disclosure is defined merely by the appended claims and their equivalents.

1. An electronic device for wireless communication, comprising:
processing circuitry, configured to:
receive data from a network-side device, wherein the data is transmitted using one of or both a current beam and a next beam for a user equipment at least partly based on a relationship between a position of the user equipment and an overlapping coverage region of the current beam and the next beam.

2. The electronic device according to claim 1, wherein the overlapping coverage region has an entry-side edge for the user equipment to enter the overlapping coverage region and an exit-side edge for the user equipment to leave the overlapping coverage region.

3. The electronic device according to claim 2, wherein the processing circuitry is further configured to:
not perform beam measurement before the user equipment reaches the entry-side edge: and
perform beam measurement for the next beam with the network-side device after the user equipment reaches the entry-side edge, and report a beam measurement result to the network-side device for the network-side device to transmit the data using one of or both the current beam and the next beam based on the beam measurement result.

4. The electronic device according to claim 3, wherein the processing circuitry is further configured to:
in a case that the beam measurement result of the next beam is higher than a first threshold for a first time period, transmit a first measurement result report to the network-side device, and receive the data transmitted from the network-side device using both the current beam and the next beam.

5. The electronic device according to claim 3, wherein the processing circuitry is further configured to:
in a case that the beam measurement result of the next beam is higher than a second threshold for a second time period, transmit a second measurement result report to the network-side device, and receive the data transmitted from the network-side device only using the next beam.

6. The electronic device according to claim 2, wherein the processing circuitry is further configured to:
in a case of not performing beam measurement,
after the user equipment reaches the entry-side edge, receive the data transmitted from the network-side device using both the current beam and the next beam; and/or
after the user equipment reaches the exit-side edge, receive the data transmitted from the network-side device only using the next beam.

7. The electronic device according to claim 1, wherein the user equipment is on a transportation vehicle with a predetermined movement path.

8. The electronic device according to claim 7, wherein the processing circuitry is further configured to:
obtain information about the current beam, information about the next beam, and information about an edge of the overlapping coverage region from the network-side device.

9. (canceled)

10. The electronic device according to claim 8, wherein the information about the edge of the overlapping coverage region indicates a position of the edge, and the processing circuitry is further configured to:
transmit, when an actual position of the user equipment reaching the edge is inconsistent with the predicted position, a deviation report indicating the inconsistency to the network-side device.

11. An electronic device for wireless communication, comprising:
processing circuitry, configured to:
transmit data to a user equipment using one of or both a current beam and a next beam for the user equipment at least partly based on a relationship between a position of the user equipment and an overlapping coverage region of the current beam and the next beam.

12. The electronic device according to claim 11, wherein the overlapping coverage region has an entry-side edge for the user equipment to enter the overlapping coverage region and an exit-side edge for the user equipment to leave the overlapping coverage region.

13. The electronic device according to claim 12, wherein the processing circuitry is further configured to:
not perform beam measurement with the user equipment before the user equipment reaches the entry-side edge; and
performs beam measurement for the next beam with the user equipment after the user equipment reaches the entry-side edge, receive a beam measurement result from the user equipment, and transmit the data to the user equipment using one of or both the current beam and the next beam based on the beam measurement result.

14. The electronic device according to claim 13, wherein the processing circuitry is further configured to:
receive a first measurement result report that is transmitted from the user equipment in a case that the beam measurement result of the next beam is higher than a first threshold for a first time period, and transmit the data to the user equipment using both the current beam and the next beam based on the first measurement result report.

15. The electronic device according to claim 13, wherein the processing circuitry is further configured to:
receive a second measurement result report that is transmitted from the user equipment in a case that the beam measurement result of the next beam is higher than a second threshold for a second time period, and transmit the data to the user equipment only using the next beam based on the second measurement result report.

16. The electronic device according to claim 12, wherein the processing circuitry is further configured to:
in a case of not performing beam measurement with the user equipment,
after the user equipment reaches the entry-side edge, transmit the data to the user equipment using both the current beam and the next beam; and/or
after the user equipment reaches the exit-side edge, transmit the data to the user equipment only using the next beam.

17. The electronic device according to claim 11, wherein the user equipment is on a transportation vehicle with a predetermined movement path, and the processing circuitry is further configured to:
obtain information about the predetermined movement path from another device: and
determine the position, the current beam and the next beam of the user equipment at least partly based on the information about the predetermined movement path.

18. The electronic device according to claim 16, wherein the processing circuitry is further configured to:
provide the user equipment with information about the current beam, information about the next beam, and information about an edge of the overlapping coverage region.

19. (canceled)

20. The electronic device according to claim 18, wherein the information about the edge of the overlapping coverage region indicates a position of the edge, and the processing circuitry is further configured to:
receive a deviation report that is transmitted from the user equipment when an actual position of the user equipment reaching the edge is inconsistent with the predicted position and that indicates the inconsistency.

21. The electronic device according to claim 20, wherein the processing circuitry is further configured to:
determine the position, the current beam and the next beam of the user equipment with reference to the deviation report.

22.-25. (canceled)

26. A method for wireless communication, comprising:
transmitting data to a user equipment using one of or both a current beam and a next beam for the user equipment at least partly based on a relationship between a position of the user equipment and an overlapping coverage region of the current beam and the next beam.

27.-28. (canceled)
